(19) United States
(12) Patent Application Publication
(10) Pub. No.: US 2025/0074095 A1
(43) Pub. Date: Mar. 6, 2025

(54) INK JET RECORDING METHOD, INK JET RECORDING APPARATUS AND AQUEOUS INK

(71) Applicant: CANON KABUSHIKI KAISHA, Tokyo (JP)

(72) Inventors: ARIKA TANAKA, Kanagawa (JP); TSUYOSHI KANKE, Kanagawa (JP); ARIHIRO SAITO, Saitama (JP); YUKA WATANABE, Tokyo (JP); ERI KOBAYASHI, Kanagawa (JP)

(21) Appl. No.: 18/814,345

(22) Filed: Aug. 23, 2024

(30) Foreign Application Priority Data
Aug. 30, 2023 (JP) 2023-139411
Aug. 5, 2024 (JP) 2024-128715

(51) Int. Cl. B41M 3/00; C09D 11/037; C09D 11/322; C09D 11/324; C09D 11/38; C09D 11/40; C09D 11/54

(52) U.S. Cl. CPC B41M 3/008; B41M 3/001; C09D 11/037; C09D 11/322; C09D 11/324; C09D 11/38; C09D 11/40; C09D 11/54

(57) ABSTRACT

An ink jet method includes applying a first ink, a second ink, a first reaction liquid and a second reaction liquid to a recording medium to overlap each other in at least an area of the recording medium to form an image. The method includes a first reaction liquid applying step of applying the first reaction liquid to the recording medium, a first ink applying step of applying the first ink to the recording medium after the first reaction liquid applying step, a second ink applying step of applying the second ink to the recording medium after the first reaction liquid applying step and a second reaction liquid applying step of applying the second reaction liquid to the recording medium after the first reaction liquid applying step. The second reaction liquid has a higher surface tension than the first reaction liquid.

### BACKGROUND OF THE INVENTION

### Field of the Invention

The present disclosure relates to an ink jet recording method, an ink jet recording apparatus and an aqueous ink.

### Description of the Related Art

In recent years, the ink jet recording method has been increasingly used in a field known as sign-and-display to print, for example, posters and large-format advertisements. One of the characteristics of this field is that the apparatus used in this field has a larger recording area than a home ink jet recording apparatus. In addition, because the image must be eye-catching, the ink is required to be capable of recording images having high color development properties.

The sign-and-display field often uses less absorbent recording media whose surfaces are formed of vinyl chloride or polyethylene terephthalate, which have little ink absorbency, and non-absorbent recording media that do not absorb ink. Hereinafter, these recording media may be collectively referred to as “less- or non-absorbent recording media”. When an image is recorded on a less- or non-absorbent recording medium, the recording medium absorbs less ink or does not absorb ink. Thus, it is required to reduce ink blur to improve image sharpness. In other words, it is important for the ink jet recording method that records on a less- or non-absorbent recording medium to prevent ink dots from being repelled on the recording medium in order to reduce ink blur and improve the image sharpness. To achieve this, the ink must be rapidly thickened and fixed immediately after applied to the recording medium.

Known examples of the method of recording on less- or non-absorbent recording medium include a method that uses a solvent-based ink containing an organic solvent as the main component and a method that uses a curable ink that contains a polymerizable monomer. In recent years, however, from the viewpoint of environmental impact and safety, there is a growing need for a recording method that can use an aqueous ink to record on a less- or non-absorbent recording medium.

The methods of recording on a less- or non-absorbent recording medium using an aqueous ink include a method in which a liquid component such as water in the ink is evaporated on the surface of the less- or non-absorbent recording medium and a method that uses a reaction liquid that aggregates the ink components. The former, which does not require a reaction liquid applicator, is advantageous in terms of running cost, but the recording speed is slow and thus has low productivity. Japanese Patent Laid-Open No. 2020-044724 and Japanese Patent Laid-Open No. 2015-147405 each discuss the method using a reaction liquid.

Referring to the description in Japanese Patent Laid-Open No. 2020-044724, the inventors of the present disclosure applied, when the first and second inks are applied, a reaction liquid in two parts on a less- or non-absorbent recording medium and evaluated the properties. Furthermore, the first reaction liquid, the second reaction liquid, the first ink and the second ink described in Japanese Patent Laid-Open No. 2015-147405 were used to record on a less- or non-absorbent recording medium, and various properties were evaluated. The results showed that, in all cases examined, there was a difference in the appearance between the image formed of the second reaction liquid and the second ink applied in layers on the area having the first reaction liquid and the first ink and the image formed only of the second reaction liquid and the second ink. Specifically, since the reaction liquids do not have the compositions suitable for the inks, when the second reaction liquid and the second ink are applied to an area where the first reaction liquid and the first ink have been applied, the second ink tends to blur, resulting in insufficient sharpness of the image.

### SUMMARY OF THE INVENTION

The present disclosure provides an ink jet recording method that can record an image having high sharpness even when inks are applied in layers on a less- or non-absorbent recording medium. The present disclosure further provides an ink jet recording apparatus and an aqueous ink that are used in this ink jet recording method.

The present disclosure provides an ink jet recording method comprising ejecting: a first ink that is an aqueous ink comprising at least one particulate component selected from the group consisting of a pigment and a resin particle; a second ink that is an aqueous ink comprising a pigment; a first reaction liquid that is an aqueous reaction liquid comprising a reactant that reacts with at least one selected from the group consisting of the first ink and the second ink; and a second reaction liquid that is an aqueous reaction liquid comprising a reactant that reacts with at least one selected from the group consisting of the first ink and the second ink, from a recording head to a recording medium to overlap each other in at least an area of the recording medium to form an image, wherein the method includes: a first reaction liquid applying step of applying the first reaction liquid to the recording medium; a first ink applying step of applying the first ink to the recording medium after the first reaction liquid applying step; a second ink applying step of applying the second ink to the recording medium after the first reaction liquid applying step; and a second reaction liquid applying step of applying the second reaction liquid to the recording medium after the first reaction liquid applying step, the recording medium exhibits a water absorption of 10 mL/m² or less for a period of 30 ms^{1/2} from the beginning of contact with water when measured by a Bristow method, and the second reaction liquid has a higher surface tension than the first reaction liquid.

Further features of the present invention will become apparent from the following description of exemplary embodiments (with reference to the attached drawings).

### BRIEF DESCRIPTION OF THE DRAWINGS

FIG. 1 is a perspective view schematically illustrating an embodiment of an ink jet recording apparatus according to the present disclosure.

FIG. 2 is a side view schematically illustrating an embodiment of an ink jet recording apparatus according to the present disclosure.

FIG. 3 is a schematic view illustrating an embodiment of an ink jet recording apparatus according to the present disclosure.

FIG. 4 is a perspective view illustrating an example of a liquid applicator.

FIG. 5 is a cross-sectional perspective view illustrating an example of an ejection element substrate.

FIG. 6 is a schematic view illustrating an example of a liquid supply system.

FIG. 7 is a schematic view illustrating another example of a heating section.

FIG. 8 is a schematic view illustrating another example of a fixing section.

### DESCRIPTION OF THE EMBODIMENTS

The present disclosure is described in more detail below with reference to a preferred embodiment. Herein, when a compound is a salt, the salt is present in an ink while dissociating into ions, but the expression “contains a salt” is used for the sake of convenience. Ink jet aqueous inks and ink jet reaction liquids are sometimes simply described as “ink” and “reaction liquid”. The physical properties are those at room temperature (25° C.) unless otherwise specified. The terms “(meth)acrylic acid” and “(meth)acrylate” mean “acrylic acid, methacrylic acid” and “acrylate, methacrylate”, respectively.

The inventors of the present disclosure examined the reasons why the image cannot have sharpness even when an image is recorded by using a reaction liquid and two types of ink as described in Japanese Patent Laid-Open No. 2020-044724 or by using two types of reaction liquid and two types of ink as described in Japanese Patent Laid-Open No. 2015-147405. When an image is recorded on a less- or non-absorbent recording medium by using multiple inks, an ink is applied over an area where another ink has already been applied or an ink is applied to an area where no ink has been applied. In the case in which an ink is applied to an area where another ink has already been applied, unlike the case in which an ink is applied to an area where no ink has been applied, the ink tends to blur, and the line width tends to be large, even if the same amount of ink is applied. Thus, the image cannot have sharpness. The inventors of the present disclosure examined the reason why the ink tends to blur and found that the additionally applied ink not only sinks into the existing layer of ink, but also diffuses to the surface of the ink layer, i.e., blurs. It was also found that this phenomenon cannot be sufficiently prevented by presence of the reaction liquid.

In view of the above, the inventors further conducted a study on the compositions and characteristics of the pigments and reaction liquids and the condition of application. The inventors found that image sharpness can be improved by applying a specific first ink, second ink, first reaction liquid and second reaction liquid onto a recording medium in a predetermined order and controlling relationship between the surface tension of the first reaction liquid and that of the second reaction liquid.

In other words, the ink jet recording method according to the present disclosure has the following features. First, the first ink is an aqueous ink containing at least one particulate component selected from the group consisting of a pigment and a resin particle. The second ink is an aqueous ink containing a pigment. The first reaction liquid is an aqueous reaction liquid containing a reactant that reacts with at least one selected from the group consisting of the first ink and the second ink. The second reaction liquid is an aqueous reaction liquid containing a reactant that reacts with at least one selected from the group consisting of the first ink and the second ink. The method includes ejecting the first ink, the second ink, the first reaction liquid and the second reaction liquid to a recording medium to overlap each other in at least an area of the recording medium to form an image. The method includes a first reaction liquid applying step of applying the first reaction liquid to the recording medium, a first ink applying step of applying the first ink to the recording medium after the first reaction liquid applying step, a second ink applying step of applying the second ink to the recording medium after the first reaction liquid applying step, and a second reaction liquid applying step of applying the second reaction liquid to the recording medium after the first reaction liquid applying step. The recording medium exhibits a water absorption of 10 mL/m² or less for a period of 30 ms^{1/2} from the beginning of contact with water when measured by a Bristow method, and the second reaction liquid has a higher surface tension than the first reaction liquid. The inventors presumed that the improvement in sharpness of the image by the above configuration was achieved by the following mechanism.

In this disclosure, the first ink, the second ink, the first reaction liquid and the second reaction liquid are used to record images. The liquids are applied in two different orders (i) and (ii) below. The order (i) includes sequentially the first reaction liquid applying step, the first ink applying step, the second ink applying step, and the second reaction liquid applying step, and the order (ii) includes sequentially the first reaction liquid applying step, the first ink applying step, the second reaction liquid applying step and the second ink applying step. The recording of an image in this order allows the first reaction liquid to aggregate the first ink and allows the second ink and the second reaction liquid to overlap each other to form an image, improving image sharpness. The reasons for this effect are explained below.

The first ink applied after the first reaction liquid is an aqueous ink containing at least one particulate component selected from the group consisting of a pigment and a resin particle. When an image is recorded using such an ink, a porous layer having many pores between the particles is expected to be formed first on the recording medium because the particulate component is a component having a particle size. Thus, when the second ink and the second reaction liquid containing a pigment are applied in layers, the liquid components of the second ink and the second reaction liquid can readily enter the porous layer of the first ink by capillary force. This can reduce the possibility that the second ink will blur.

The likelihood of blurring when the second ink is applied on the first ink depends on the relationship between the second ink or the second reaction liquid and the surface tension of the layer of the first ink. The inventors of the present disclosure have conducted a study and found that the first and second reaction liquids contain a reactant that aggregates at least one ink component selected from the group consisting of the first ink and the second ink. Thus, it was found that the relationship between the surface tensions of the reaction liquids has a dominant influence on the likelihood of blurring of the second ink. The second reaction liquid having a higher surface tension than the first reaction liquid is more likely to stay on the layer of the first ink, allowing the second ink to aggregate more efficiently. This reduces blur caused by application of the second ink, resulting in improvement of image sharpness. If the second reaction liquid has a lower surface tension than the first reaction liquid, the second reaction liquid is less likely to stay on the layer of the first ink, not allowing the second ink to aggregate efficiently. Thus, the second ink blurs, failing to improve image sharpness.

### Ink Jet Recording Method and Ink Jet Recording Apparatus

The ink jet recording method (hereinafter may be simply referred to as “recording method”) of the present disclosure is a method in which an ink jet recording head ejects an aqueous ink and an aqueous reaction liquid using thermal energy to a recording medium to record an image. This method includes a first reaction liquid applying step of applying a first reaction liquid to a recording medium, a first ink applying step of applying a first ink to the recording medium after the first reaction liquid applying step, a second ink applying step of applying a second ink to the recording medium after the first reaction liquid applying step and a second reaction liquid applying step of applying a second reaction liquid to the recording medium after the first reaction liquid applying step. The first reaction liquid is an aqueous reaction liquid containing a reactant that reacts with at least one selected from the group consisting of the first ink and the second ink. The second reaction liquid is an aqueous reaction liquid containing a reactant that reacts with at least one selected from the group consisting of the first ink and the second ink. The method includes ejecting the first ink, the second ink, the first reaction liquid and the second reaction liquid to a recording medium to overlap each other in at least an area of the recording medium to form an image. The recording medium exhibits a water absorption of 10 mL/m² or less for a period of 30 ms^{1/2} from the beginning of contact with water when measured by a Bristow method, and the second reaction liquid has a higher surface tension than the first reaction liquid.

The ink jet recording apparatus (hereinafter may be simply referred to as “recording apparatus”) of the present disclosure is an apparatus used in an ink jet recording method in which an ink jet recording head ejects an aqueous ink and an aqueous reaction liquid using thermal energy onto a recording medium to record an image. The recording apparatus of the present disclosure is an apparatus suitable for the above-described recording method. The recording method and the recording apparatus of this disclosure do not require curing of the image, for example, by irradiation of active energy rays.

The set of aqueous ink and aqueous reaction liquid is used in an ink jet recording method in which an aqueous ink and an aqueous reaction liquid containing a reactant that reacts with the aqueous ink are ejected from a recording head to record an image on a recording medium. This set is preferably used in the above-described recording method. The set may be a set of multiple ink cartridges independently containing the inks (reaction liquids) or may be in the form of an ink cartridge integrally including multiple ink reservoirs containing the corresponding inks (reaction liquids). The set of the present disclosure is not limited to be in the above form and may be in any form that makes a combination of the ink and the reaction liquid available.

### Ink Jet Recording Apparatus

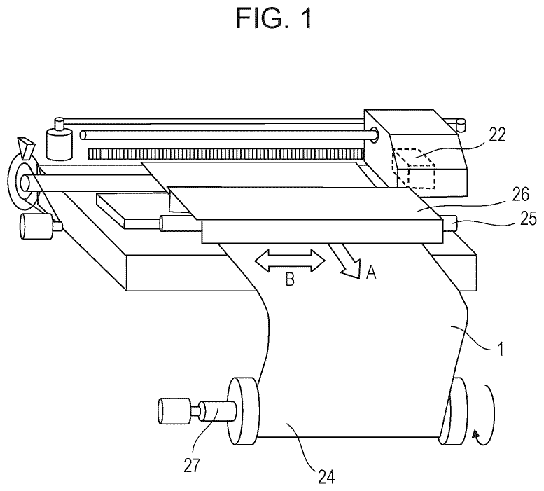

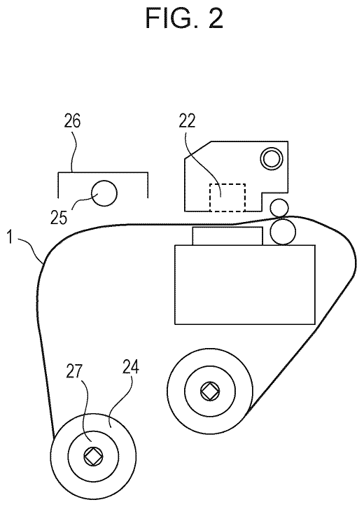

Hereinafter, the ink jet recording apparatus is described in detail with reference to the drawings. FIG. 1 is a perspective view schematically illustrating an ink jet recording apparatus according to an embodiment of the present disclosure. FIG. 2 is a side view schematically illustrating an ink jet recording apparatus according to an embodiment of the present disclosure. As illustrated in FIGS. 1 and 2, the recording apparatus of this embodiment includes an ink jet recording head 22 that ejects ink. The recording head 22 is a recording head that ejects ink by using thermal energy. A recording head that ejects ink through the action of thermal energy applies electrical pulses to the electrothermal conversion element to impart thermal energy to the ink, causing the ink to be ejected through the nozzle. In this example, the recording head that ejects ink through the action of thermal energy is used as an example, but a recording head that ejects ink through action of mechanical energy may also be used. The recording head may include a structure (temperature regulator) that heats the aqueous ink ejected from the recording head. When the recording head includes a temperature regulator, the heating temperature of ink ejected from the recording head is preferably 35° C. or more to 70° C. or less. It is also preferred that the first and second inks and the first and second reaction liquids are applied to a unit area of the recording medium while the recording head and the recording medium are moved relative to each other multiple times.

### Heating Process

The recording method of this disclosure may include a step of heating (heat processing) a recording medium having the applied ink. Heating the recording medium having the applied ink can accelerate drying and increase the image strength.

Examples of a unit that heats a recording medium include a known warmer such as a heater, an air blower using blasts of air such as a dryer and a combination of them. Examples of the heating unit include the above warmer, the air blower and the combination of them. The method of heating may include a method of applying heat to a surface (rear surface) of the recording medium opposite from the recording surface (ink receiving surface) by, for example, a heater, a method of applying warm air or hot air to the recording surface of the recording medium and a method of applying heat to the recording surface or the rear surface by an infrared heater. The methods may be used in combination.

The heating temperature of the recording medium having the applied ink and reaction liquid is preferably 50° C. or more to 90° C. or less to improve the abrasion resistance of the image. The heating temperature of the recording medium having the applied ink may be determined by using a sensor located at a position corresponding to the heating unit of the recording apparatus or may be determined from the relationship between the amount of heat set for the type of ink and the temperature of the recording medium.

In the recording apparatus illustrated in FIGS. 1 and 2, a heater 25 supported by a frame (not illustrated) is located downstream in the sub-scanning direction A from a position where the recording head 22 reciprocates in the main scanning directions B. The recording medium 1 having the applied ink can be heated by the heater 25. Specific examples of the heater 25 include a sheathed heater and a halogen heater. The heater 25 is covered by a heater cover 26. The heater cover 26 enables the heat generated by the heater 25 to be efficiently applied to the recording medium 1. The heater cover 26 also protects the heater 25. The recording medium 1 having the ink ejected from the recording head 22 is wound up by a take-up spool 27 to form a wounded medium 24 in the form of a roll.

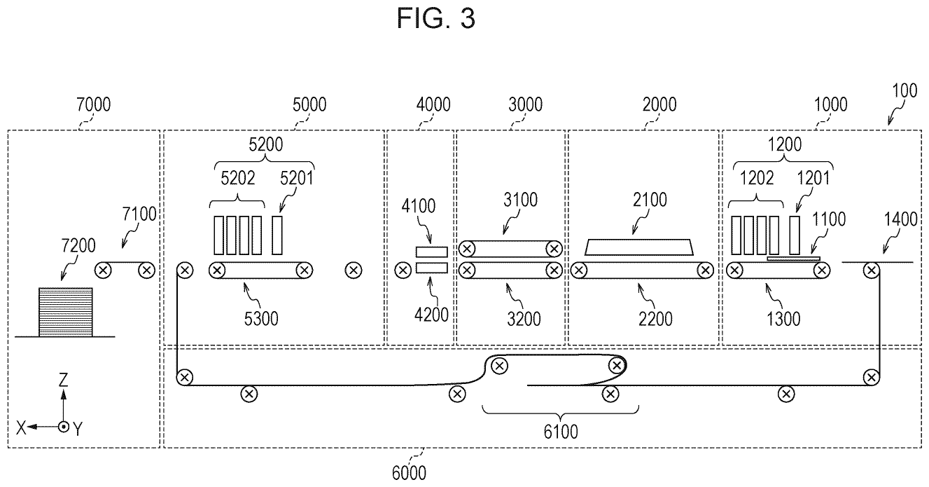

FIG. 3 is a schematic view illustrating an ink jet recording apparatus according to an embodiment of the present disclosure. This ink jet recording apparatus according to the present embodiment is an ink jet recording apparatus that uses an ink and a reaction liquid containing a reactant that reacts with the ink to record an image on a recording medium. The X, Y and Z directions indicate the widthwise direction (total-length direction), the depth direction and the height direction, respectively, of the ink jet recording apparatus. The recording medium is transported in the X direction.

The ink jet recording apparatus 100 of the embodiment illustrated in FIG. 3 includes a first recording section 1000, a heating section 2000, a fixing section 3000, a cooling section 4000, a second recording section 5000, a reversing section 6000 and a paper discharging section 7000. In the first recording section 1000, various liquids are applied by a liquid applicator 1200 to a recording medium 1100, which is transported by a transportation member 1300 from a paper feeder 1400. In the heating section 2000, the liquid applied to the recording medium 1100 is heated by a heating device 2100 to evaporate moisture and other volatile components in the liquid to dry the recording medium 1100. In the fixing section 3000, a fixing member 3100 is brought into contact with an area of the recording medium 1100 that has the liquids to heat the area, accelerating fixation of the image on the recording medium 1100. Then, the recording medium 1100 is cooled by a cooling member 4100 in the cooling section 4000. In the second recording section 5000, various liquids are applied to the recording medium 1100 by a liquid applicator 5200. When an image is recorded on a rear surface after the front surface (recording surface), the recording medium 1100 is first reversed by a reversing device 6100 in the reversing section 6000. Then, after an image is recorded on the rear surface in the same manner as on the front surface, the medium is transported by the transportation member 7100 in the paper discharging section 7000 and loaded and stored in a recording medium storage section 7200.

### Recording Section

The first recording section 1000 includes the liquid applicator 1200. The liquid applicator 1200 includes a reaction liquid applicator 1201 and an ink applicator 1202. The reaction liquid applicator 1201 illustrated in FIG. 3 is an example of a unit that includes an ink jet type ejection head. The reaction liquid applicator may be composed of a gravure coater, an offset coater, a die coater and a blade coater. The reaction liquid applicator 1201 applies a reaction liquid before the application of the first ink. The ink applicator 1202 is an ejection head (recording head) using ink jet technology. The ejection head as the liquid applicator 1200 may eject liquid, for example, by causing film boiling in a liquid to form bubbles by using an electro-thermal converter or may eject liquid by using an electro-mechanical converter. From the viewpoint of image quality, it is preferable that the time before the reaction liquid comes into contact with the ink be short. Specifically, the time from the application of the reaction liquid to the application of the ink is preferably 2500 milliseconds or less. Here, the time from the application of the reaction liquid to the application of the first ink may be the same or different from the time from the application of the reaction liquid to the application of the second ink. This time can be changed as needed by adjusting the distance between the reaction liquid applicator and the unit of applying ink or by adjusting the transportation rate of the recording medium. The time from the application of the reaction liquid to the application of the ink is preferably 100 milliseconds or more, more preferably 200 milliseconds or more.

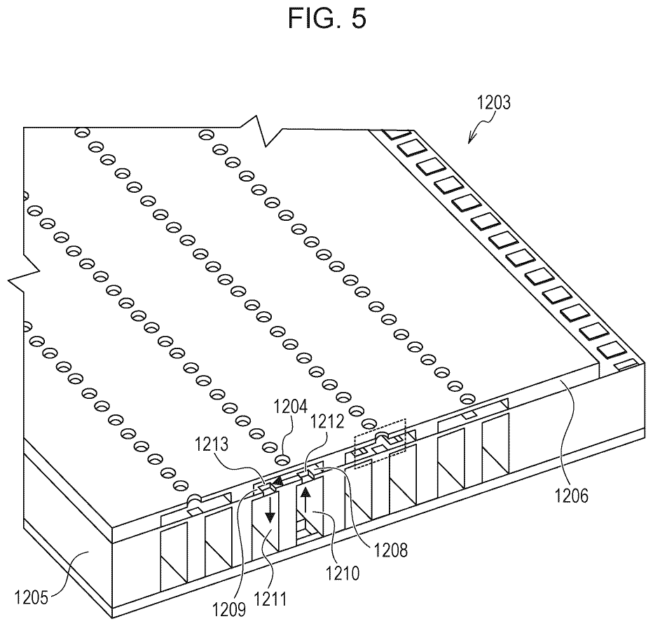

The liquid applicator 1200 is a line head extending in the Y direction and has nozzles over an image recording area of a recording medium having a maximum printable width. The ejection head has an ejection surface (FIG. 5) having nozzles on a lower side (adjacent to the recording medium 1100), and the ejection surface faces the recording medium 1100 with a minute distance of a few millimeters.

The ink applicator 1202 may include multiple ink applicators 1202 to apply various colors of ink to the recording medium 1100. For example, when yellow, magenta, cyan, and black inks are used to record color images, four ink applicators 1202 that eject the above four types of ink are arranged in the X direction. In the following description, the ink and the reaction liquid are sometimes collectively referred to as “liquid”.

The second recording section 5000 includes a liquid applicator 5200. The liquid applicator 5200 includes a reaction liquid applicator 5201 and an ink applicator 5202. The second recording section can have the same components as those of the first recording section. The first recording section and the second recording section do not need to be different sections as illustrated in FIG. 3. For example, the first recording section may have multiple reaction liquid applicators 1201 and ink applicators 1202. The recording medium that has passed through the cooling section 4000 may be returned to the first recording section by a structure to return the medium, and then the liquids are applied. In such a case, the reaction liquid applicator 1201 and the ink applicators 1202 used for the first pass through the first recording section 1000 may be different from those used for the second pass. The application of the reaction liquid by the reaction liquid applicator 5201 may be before or after the application of the second ink. In particular, the application of the reaction liquid by the reaction liquid applicator 5201 is preferably before the application of the second ink. In other words, the recording method according to the present disclosure preferably includes, in this order, the first reaction liquid applying step, the first ink applying step, the second reaction liquid applying step and the second ink applying step. This can further reduce image blur because the application of the second reaction liquid before the application of the second ink enables the second ink to start aggregating earlier. This results in further improvement of image sharpness.

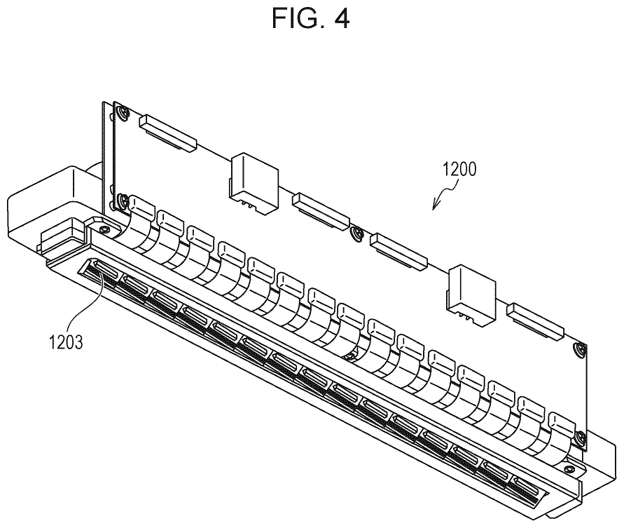

FIG. 4 is a perspective view illustrating an example of a liquid applicator. The liquid applicator 1200 illustrated in FIG. 4 is a line head in which multiple ejection element substrates 1203 having nozzle arrays are arranged in a straight line. The ejection element substrate 1203 has multiple nozzle arrays.

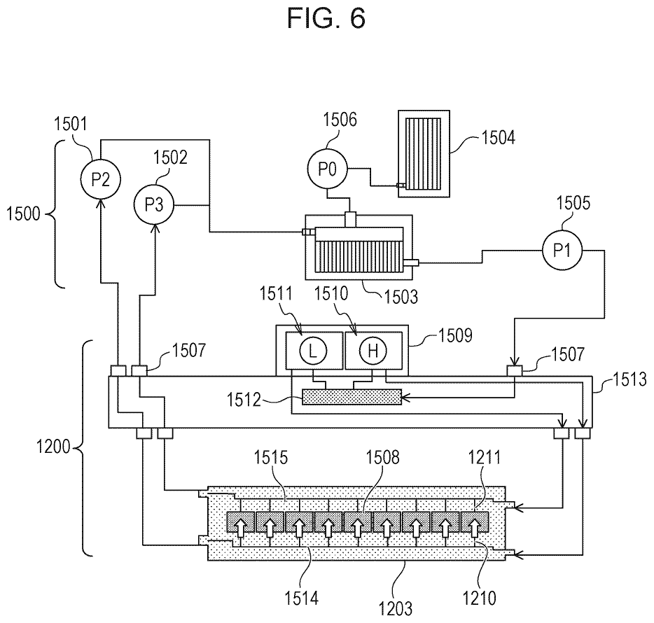

FIG. 5 is a cross-sectional perspective view illustrating an example of an ejection element substrate. The ejection element substrate 1203 illustrated in FIG. 5 includes a nozzle forming member 1206 having nozzles 1204 and a substrate 1205 on which the ejection elements (not illustrated) are arranged. The nozzle forming member 1206 and the substrate 1205 stacked on top of another form a first channel 1208 and a second channel 1209 through which liquid flows. The first channel 1208 extends from an inlet 1212, through which liquid flows in from an inlet channel 1210, to a portion (FIG. 6, a liquid chamber 1508) between the nozzle 1204 and the ejection element. The second channel 1209 extends from the portion between the nozzle 1204 and the ejection element (FIG. 6, liquid chamber 1508) to the outlet 1213, through which the liquid flows out to an outlet channel 1211. For example, a pressure difference between the inlet 1212 and the outlet 1213, such as a higher pressure inlet 1212 and a lower pressure outlet 1213, allows liquid to flow from a higher pressure to a lower pressure (in the directions of the arrows in FIG. 5). The liquid passing through the inlet channel 1210 and the inlet 1212 enters the first channel 1208. Then, the liquid passing through the portion (FIG. 6, the liquid chamber 1508) between the nozzle 1204 and the ejection element flows through the second flow channel 1209 and the outlet 1213 to the outlet channel 1211.

### Supply System

FIG. 6 is a schematic view illustrating an example of a supply system of ink and other liquids. A supply section 1500 of the liquid applicator 1200 illustrated in FIG. 6 includes a first circulation pump (high pressure side) 1501, a first circulation pump (low pressure side) 1502, a sub-tank 1503 and a second circulation pump 1505. The sub-tank 1503, which is connected to a main tank 1504 as a liquid container, has an atmosphere communication hole (not illustrated) through which air bubbles in the liquid are discharged from the supply system. The sub-tank 1503 is also connected to a refill pump 1506. The liquid applicator 1200 ejects (discharges) liquid through the nozzles to record images and perform suction recovery and thus consumes liquid. The refill pump 1506 sends the liquid from the main tank 1504 to the sub-tank 1503 in an amount equal to the consumed amount.

The first circulation pump (high pressure side) 1501 and the first circulation pump (low pressure side) 1502 allow the liquid discharged from the liquid applicator 1200 through a connection portion (inlet portion) 1507 to flow to the sub-tank 1503. The first circulation pump (high pressure side) 1501, the first circulation pump (low pressure side) 1502 and the second circulation pump 1505 each are preferably a positive displacement pump having a quantitative pumping capacity. Examples of the positive displacement pump include a tube pump, a gear pump, a diaphragm pump and a syringe pump. When the ejection element substrate 1203 is driven, the first circulation pump (high pressure side) 1501 and the first circulation pump (low pressure side) 1502 allow liquid to flow from a common inlet channel 1514 to a common outlet channel 1515.

A negative pressure control unit 1509 includes two pressure regulators having different preset control pressures. A pressure regulator (high pressure side) 1510 and a pressure regulator (low pressure side) 1511 are connected to the common inlet channel 1514 and the common outlet channel 1515 in the ejection element substrate 1203, respectively, via a supply unit 1513, which has a filter 1512 to remove foreign component from the liquid. The ejection element substrate 1203 has the common inlet channel 1514, the common outlet channel 1515, the inlet channel 1210 and the outlet channel 1211 that are in communication with the liquid chambers 1508 located between the nozzles 1204 and the ejection elements (not illustrated). The inlet channel 1210 and the outlet channel 1211 are in communication with the common inlet channel 1514 and the common outlet channel 1515, respectively, so that a portion of the liquid flows (arrows in FIG. 6) from the common inlet channel 1514 to the common outlet channel 1515 through the liquid chambers 1508. The arrow in FIG. 5 indicates the flow of liquid inside the liquid chamber 1508. In other words, as illustrated in FIG. 5, the liquid in the first channel 1208 flows into the second channel 1209 through the space between the nozzle 1204 and the ejection element.

As illustrated in FIG. 6, the common inlet channel 1514 is connected to a pressure regulator (high pressure side) 1510, and the common outlet channel 1515 is connected to a pressure regulator (low pressure side) 1511, creating a pressure difference between the inlet channel 1210 and the outlet channel 1211. This also creates a pressure difference between the inlet 1212 (FIG. 5), which is in communication with the inlet channel 1210, and the outlet 1213 (FIG. 5), which is in communication with the outlet channel 1211. When liquid is made to flow by the pressure difference between the inlet 1212 and the outlet 1213, the liquid flow velocity (mm/s) is preferably controlled at 0.1 mm/s or more to 10.0 mm/s or less.

### Transportation System

As illustrated in FIG. 3, the first recording section 1000 includes the liquid applicator 1200 and the transportation member 1300 that transports the recording medium 1100. The liquid applicator 1200 applies reaction liquid and ink to a desired position of the recording medium 1100 transported by the transportation member 1300. Upon reception of image signals of the recording data, the liquid applicators each apply the necessary reaction liquid and ink to the positions. In FIG. 3, the transportation member 1300 is a transport belt but may be any member that can transport the recording medium 1100, such as a spur and a transport cylinder. To improve transport accuracy, the transportation member 1300 may have a function of fixing the recording medium 1100. Specifically, the transportation member 1300 may have holes that allow the recording medium 1100 to be fixed by suctioning from the rear surface, or the transportation member 1300 may be formed of an appropriate component that electrostatic adsorbs and fixes the recording medium 1100. The second recording section 5000 can have the same configuration as the first recording section 1000.

### Heating Section

As illustrated in FIG. 3, the heating section 2000 includes the heating device 2100 and the transportation member 2200. The recording medium 1100 having the image recorded by application of the reaction liquid and ink is heated by the heating device 2100 while being transported by the transportation member 2200 so that the liquid component of the image is evaporated and dried. Between the ink applying step and the fixing step, a drying step is preferably performed in which the recording medium is non-contact heated to dry the ink. This drying step can effectively reduce deformation (cockling and curling) of the recording medium 1100.

The heating device 2100 can have any configuration that can heat the recording medium 1100. Any conventionally known device, such as a warm air dryer and a heater, can be employed. Among them, non-contact heaters such as electric heating wires and infrared rays are preferred in view of safety and energy efficiency. Furthermore, the drying efficiency can be readily improved by a structure that sends warm air by using a built-in fan configured to blow heated gas toward the recording medium 1100.

The recording medium 1100 may be heated from the surface having the applied reaction liquid and ink (recording surface (front surface)) or from the rear surface or from both sides. The transportation member 2200 may have a heating function. In FIG. 3, the transportation member 2200 uses a transport belt but may use any member that can transport the recording medium 1100, such as a spur and a transport cylinder. To reduce deformation of the recording medium 1100 caused by heating, the apparatus preferably has a configuration that blows air from the heating section 2000 to allow the recording medium 1100 to be in close contact with the transportation member 2200 while being transported or a structure that fixes the recording medium 1100 to the transportation member 2200. Specifically, the transportation member 2200 may have holes that allow the recording medium 1100 to be fixed by suctioning from the rear surface, or the transportation member 2200 may be formed of an appropriate component that fixes the recording medium 1100 by electrostatic adsorption.

The heating temperature is preferably set at a temperature that allows rapid evaporation of the liquid component and that does not allow over-drying to reduce deformation of the recording medium 1100. The temperature of a dryer can be set in view of the transportation rate and the ambient temperature so that the recording medium has a desired temperature. Specifically, the temperature of the dryer (e.g., warm air) is preferably 40° C. or higher to 100° C. or lower, more preferably 60° C. or higher to 80° C. or lower. When heated air is blown to heat the recording medium 1100, the wind speed is preferably 1 m/s or more to 100 m/s or less. The temperature of air such as warm air can be measured using a K-type thermocouple thermometer. A specific example of the thermometer is “AD-5605H” (trade name) available from A&D Company, Limited.

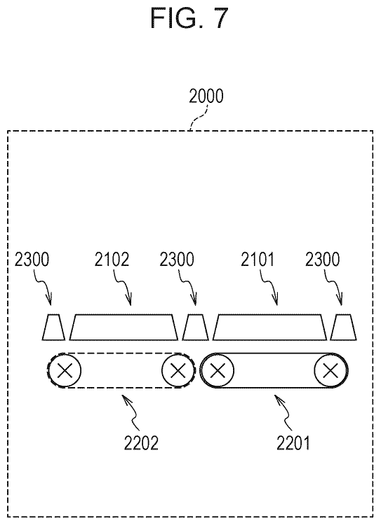

FIG. 7 is a schematic view illustrating another example of the heating section. The following describes differences between this heating section and the above-described heating section illustrated in FIG. 3. The heating section 2000 illustrated in FIG. 7 includes a first heating device 2101, a second heating device 2102, a first transportation member 2201 opposed to the first heating device 2101 and a second transportation member 2202 opposed to the second heating device 2102.

The first transportation member 2201 does not have a structure that fixes the recording medium 1100 by suctioning. The recording medium 1100 is transported while being pressed against the first transportation member 2201 by warm air sent from the first heating device 2101. This enables the recording medium 1100 to be reliably sent from the transportation member 1300 (FIG. 3) to the first transportation member 2201 and from the first transpiration member 2201 to the second transportation member 2202. Furthermore, this can reduce transportation displacement caused by a slight difference in the transportation rate between the transportation member 1300 (FIG. 3) and the first transpiration member 2201. As the second transportation member 2202, a transport belt having holes through which gas can pass is used. The recording medium 1100 is transported while being fixed to the second transportation member 2202 by a suctioning structure (not illustrated).

An air knife 2300 is provided in each space between the transportation member 1300 (FIG. 3) and the first transportation member 2201, between the first transportation member 2201 and the second transportation member 2202 and between the second transportation member 2202 and the transportation member 3200 (FIG. 3). The air pressure from the air knife 2300 holds down the lifted front end of the recording medium 1100 being transported. This prevents the front end of the recording medium 1100 from coming into contact with the first heating device 2101, the second heating device 2102 and the fixing member 3100 (FIG. 3), reducing the possibility of transport defects.

The first heating device 2101 and the second heating device 2102 can have the same configuration as that of the above-described heating device 2100. The first and second heating devices 2101 and 2102 may have the same or different temperatures or may send heated gas for heating at the same or different speeds. The recording medium may be heated from the first and second transportation members 2201 and 2202 as needed.

### Fixing Section

As illustrated in FIG. 3, the fixing section 3000 is a contact-heating and pressurizing structure that includes the fixing member 3100 in the form of a fixing belt, such as an endless belt, and the transportation member 3200. In the fixing section 3000, the transportation member 3200 transports the recording medium 1100, and the liquid such as the reaction liquid and the ink applied to the recording medium 1100 is heated with the fixing member 3100 being in contact with the recording medium 1100 under pressure. This enables the image to be fixed to the recording medium 1100. After the liquid components such as the reaction liquid and the ink permeate the recording medium 1100 or evaporate from the recording medium 1100 having the recorded image by passing through the heating section 2000, the liquid components are fixed in the fixing section 3000, and thus the image is completed. The recording medium 1100 is heated and pressurized while being sandwiched between the fixing member 3100 and the transportation member 3200, allowing an image on the recording medium 1100 to be in close contact with the fixing member 3100 and fix to the recording medium 1100. When a liquid such as ink containing a resin particle and a coloring component is used, the resin particle is softened and forms a film mainly when heated in the fixing section 3000, enabling the coloring component to be bound onto the recording medium 1100. The fixing section may be eliminated from the recording method and the recording apparatus according to the present disclosure. In such a case, the recording medium may be dried and fixed in the heating section.

A heat source such as a halogen heater may be provided in a roller that drives the fixing member 3100 in the form of a fixing belt to heat the fixing member 3100. Alternatively, a heat source such as an infrared heater may be provided at a position away from the fixing member 3100 to heat the fixing member 3100. These heating methods may be used in combination. The transportation member 3200 may be heated as necessary. The temperature of the fixing member 3100 can be set in view of the transportation rate and the ambient temperature so that the recording medium has a desired temperature. Specifically, the temperature of the fixing member 3100 is preferably 50° C. or higher to 120° C. or lower, more preferably 60° C. or higher to 110° C. or lower. Both the temperature of the contact-heating and pressurizing structure (fixing member 3100) and the surface temperature of the recording medium immediately after passed through the contact-heating and pressurizing structure can be measured using a radiation thermometer. A radiation thermometer only needs to be located near the end (terminal) of the contact-heating and pressurizing structure. A specific example of the radiation thermometer is “Radiation Thermometer IT-545S” (trade name) available from HORIBA, Ltd.

The first ink, which will be described below, contains a particle (wax particle) formed of a resin particle and wax. Thus, if the temperature of the fixing member 3100 is set to a temperature higher than the glass transition temperature of the resin particle in the ink, the resin particle will be softened to allow easy formation of a film, improving the abrasion resistance of the image. The temperature of the fixing member 3100 is preferably lower than the melting point of the wax constituting the wax particle. This allows the wax, which is less likely to melt, to stay on the surface of the image, improving the abrasion resistance of the image.

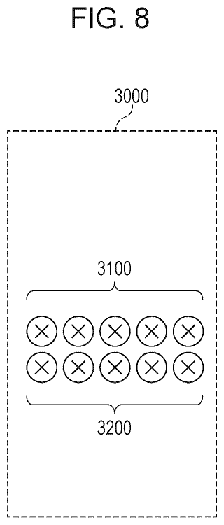

The nip pressure between the fixing member 3100 and the transportation member 3200, i.e., the pressure applied to the recording medium passing through the contact-heating and pressurizing structure is preferably 10 Pa or more to 1,000 Pa or less, more preferably 10 Pa or more to 500 Pa or less. Furthermore, the pressure is particularly preferably 10 Pa or more to 400 Pa or less. The time (nipping time) required for the recording medium to pass through the contact-heating and pressurizing structure is preferably 0.25 second or more to 5.0 seconds or less, more preferably 0.5 second or more to 4.0 seconds or less, still more preferably 1.0 second or more to 3.0 seconds or less. FIG. 8 is a schematic view illustrating another example of the fixing section. The following describes differences between this fixing section and the above-described fixing section illustrated in FIG. 3. The fixing section 3000 illustrated in FIG. 8 is a contact-heating and pressurizing structure including multiple fixing rollers 3100 and multiple transportation members 3200 opposed to these fixing rollers 3100. The image is fixed to the recording medium by passing the recording medium 1100 having the applied liquid such as ink between the fixing rollers 3100 and the transportation members 3200. The degree of image fixation to the recording medium can be adjusted by controlling, for example, the number of fixing rollers 3100, the number of transportation members 3200, the nip time of the recording medium between the fixing rollers 3100 and the transportation members 3200, the temperature and the pressure.

### Cooling Section

The cooling section 4000 includes the cooling member 4100 and the transportation member 4200 (FIG. 3). The cooling section 4000 cools the recording medium 1100 that has been heated by passing through the heating section 2000 and the fixing section 3000. The cooling member 4100 may have any configuration that can cool the recording medium 1100 by, for example, air-cooling or water-cooling. In particular, blowing unheated gas is preferred in view of safety and energy efficiency. Furthermore, the cooling efficiency can be readily improved by a structure that sends air by using a built-in fan for blowing gas toward the recording medium 1100. The temperature of the cooler can be set in view of the transportation rate and the ambient temperature so that the recording medium has a desired temperature. Specifically, the temperature of the cooler (e.g., air blower) is preferably 20° C. or more to 60° C. or less, more preferably 25° C. or more to 50° C. or less. When gas is sent for cooling, the wind speed is preferably 1 m/s or more to 100 m/s or less. These conditions can reduce deformation and image sticking (blocking) of the recording medium 1100 to be loaded in the paper discharging section 7000, which will be described below.

The above-described heating section, fixing section, and cooling section may be provided downstream of the second recording section 5000. In such a case, the configuration may be the same as or different from those described above.

### Reversing Section

For double-sided recording, the recording medium 1100 is reversed using the reversing section 6000 (FIG. 3). After passing through the cooling section 4000, the recording medium 1100 having an image recorded on its recording surface (front surface) is transported on a branched path to be reversed by the reversing device 6100. The reversed recording medium 1100 is transported to the paper feeder 1400 of the recording section 1000 in a state that allows liquid to be applied on its rear surface (opposite side of the recording surface (front surface)).

### Paper Discharging Section

The recording medium 1100 after the image recording is housed in the paper discharging section 7000 (FIG. 3). After single-sided or double-sided recording, the recording medium 1100 that has passed through the cooling section 4000 is transported by the transportation member 7100 to be finally stored in the recording medium housing 7200. Two or more recording medium housings 7200 may be provided, for example, to store different recording media.

### Recording Medium

The recording method and the recording apparatus according to the present disclosure use a less- or non-absorbent recording medium. A less- or non-absorbent recording medium is defined as below. The less- or non-absorbent recording medium is a recording medium that exhibits a water absorption of 0 mL/m² or more to 10 mL/m² or less for a period of 30 ms^{1/2} from the beginning of contact with water when measured by a

Bristow method described in “Paper and Cardboards-Liquid Absorption Test” in JAPAN TAPPI Pulp and Paper Test Methods No. 51. In this disclosure, a recording medium that satisfies the above condition of a water absorption amount is defined as a “less- or non-absorbent recording medium”. A recording medium for ink jet recording (e.g., glossy paper and matte paper) having a coating layer (ink receptive layer) formed of an inorganic particle and plain paper not having a coating layer are “absorbent recording media” that have the above water absorption amount of more than 10 mL/m².

Examples of the less- or non-absorbent recording medium include a plastic film, a recording medium having a plastic film bonded to a recording surface of a base component and a recording medium having a resin-coated layer on a recording surface of a base component containing cellulose pulp. Among them, the recording medium is preferably a plastic film and also preferably a recording medium having a resin-coated layer on a recording surface of a base component containing cellulose pulp. The basis weight (g/m²) of the recording medium 1100 is preferably 30 g/m² or more to 500 g/m² or less, more preferably 50 g/m² or more to 450 g/m² or less.

When the ink described below, which is used in the recording method and the recording apparatus of the present disclosure, is applied to a less- or non-absorbent recording medium, water and other liquid components evaporate from the ink, resulting in condensation of the resin particle. This promotes fusion between the concentrated resin particle, increasing the recorded image intensity. In contrast, when the ink described below is applied to a recording medium having high absorption of liquid components, the fusion between the resin particles is less promoted, failing to improve the image intensity. In this specification, a recording medium means a recording medium on which an image as a recording object is to be recorded, not a transfer member.

### First Reaction Liquid

The recording method of the present disclosure includes a first reaction liquid applying step of applying a first reaction liquid, which is an aqueous reaction liquid containing a reactant that reacts with at least one aqueous ink selected from the group consisting of the first ink and the second ink, onto a recording medium. Hereinafter, components of the first reaction liquid will be described in detail.

### Reactant

The first reaction liquid, which reacts with the ink when it comes into contact with the ink and aggregates the components in the ink (components having an anionic group such as a resin, a surfactant and a self-dispersing pigment), contains a reactant. Due to the presence of the reactant, when the ink comes into contact with the reactant on the recording medium, the existential state of the component having an anionic group in the ink is destabilized, promoting ink aggregation. Examples of the reactant include a cationic component, such as a polyvalent metal ion and a cationic resin, and an organic acid. Among them, the first reaction liquid preferably contains a polyvalent metal salt. The reactants may be used either alone or in combination.

The polyvalent metal salt content (% by mass) of the first reaction liquid is preferably 1.0% by mass or more to 20.0% by mass or less based on the total mass of the reaction liquid. In this specification, the “polyvalent metal salt content (% by mass)” of the reaction liquid when the polyvalent metal salt is hydrate means the “anhydrous polyvalent metal salt content (% by mass)” excluding water as hydrate.

Examples of the polyvalent metal ion, which constitutes a polyvalent metal salt, include divalent metal ions such as Ca²⁺, Cu²⁺, Ni²⁺, Mg²⁺, Sr²⁺Ba²⁺ and Zn²⁺, and trivalent metal ions, such as Fe³⁺, Cr³⁺, Y³⁺ and Al³⁺. To add a polyvalent metal ion to the reaction liquid, a water-soluble polyvalent metal salt (which may be a hydrate) in which a polyvalent metal ion and an anion are combined can be used. Examples of the anion include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻ and organic anions such as HCOO⁻, (COO⁻)₂, COOH(COO⁻), CH₃COO⁻, CH₃CH(OH)COO⁻, C₂H₄ (COO⁻)₂⁻, C₆H₅COO⁻, C₆H₄(COO⁻)₂ and CH₃SO₃⁻.

As the reactant in the first reaction liquid, magnesium sulfate is preferred among the polyvalent metal salts. In other words, the polyvalent metal salt in the first reaction liquid is preferably magnesium sulfate. This is because the aggregation speed of solid components of the ink, such as a particulate component, can be readily adjusted by the reactant content of the reaction liquid and the application amount of the reaction liquid. When the reactant is magnesium sulfate, the magnesium sulfate content (% by mass) of the first reaction liquid is preferably 1.0% by mass or more to 15.0% by mass or less, more preferably 2.0% by mass or more to 10.0% by mass or less, based on the total mass of the reaction liquid.

As mentioned above, the reactants may be used either alone or in combination. It is preferable that the reactant in the first reaction liquid further contain a cationic resin to enhance the aggregation power of the ink. The cationic resin content (% by mass) of the first reaction liquid is preferably 0.1% by mass or more to 10.0% by mass or less, more preferably 0.2% by mass or more to 5.0% by mass or less, based on the total mass of the reaction liquid. In particular, the cationic resin content is preferably 0.5% by mass or more to 5.0% by mass or less.

Examples of the cationic resin include a resin having a primary to tertiary amine structure and a resin having a quaternary ammonium salt structure. Specific examples include resins having structures of vinylamine, allylamine, vinylimidazole, vinylpyridine, dimethylaminoethyl methacrylate, ethyleneimine, guanidine, diallyldimethylammonium chloride and alkylamine-epichlorohydrin condensation. In order to improve the solubility in the reaction liquid, the cationic resin may be used in combination with an acidic compound, or the cationic resin may be subjected to quaternarization treatment.

The reaction liquid containing an organic acid has a buffer capacity in an acidic region (less than pH 7.0, preferably pH 2.0 to pH 5.0), efficiently making the anionic group of the component in an ink be in an acid form and causing the component to aggregate. Examples of the organic acid include monocarboxylic acids such as formic acid, acetic acid, propionic acid, butyric acid, benzoic acid, glycolic acid, lactic acid, salicylic acid, pyrrole carboxylic acid, furan carboxylic acid, picolinic acid, nicotinic acid, thiophene carboxylic acid, levulinic acid and coumaric acid and salts thereof, dicarboxylic acids such as oxalic acid, malonic acid, succinic acid, glutaric acid, adipic acid, maleic acid, fumaric acid, itaconic acid, sebacic acid, phthalic acid, malic acid and tartaric acid and salts and hydrogen salts thereof, tricarboxylic acids such as citric acid and trimellitic acid and salts and hydrogen salts thereof, tetracarboxylic acids such as pyromellitic acid and salts and hydrogen salts thereof. When the reactant is an organic acid, the organic acid content (% by mass) of the first reaction liquid is preferably 1.0% by mass or more to 50.0% by mass or less, based on the total mass of the reaction liquid.

### Aqueous Medium

The first reaction liquid is an aqueous reaction liquid containing at least water as an aqueous medium. The aqueous medium included in the reaction liquid can be the same as that exemplified below as the aqueous medium that can be contained in the ink. A water-soluble organic solvent content (% by mass) of the first reaction liquid is preferably 1.0% by mass or more to 45.0% by mass or less, based on the total mass of the reaction liquid. The first water-soluble organic solvent preferably contains a specific water-soluble hydrocarbon compound described below. A water-soluble hydrocarbon compound content (% by mass) of the first reaction liquid is preferably 1.0% by mass or more to 20.0% by mass or less, based on the total mass of the reaction liquid. A water content (% by mass) of the first reaction liquid is preferably 50.0% by mass or more to 95.0% by mass or less, based on the total mass of the reaction liquid.

### Other Components

The first reaction liquid may contain various other components as needed. Examples of the other components may be the same as those exemplified below as other components that can be contained in the ink. However, a surfactant should not be included in the water-soluble organic solvent.

### Physical Properties of Reaction Liquid

The first reaction liquid is an aqueous reaction liquid applicable to the ink jet system. Thus, in view of reliability, it is preferable that the physical properties of the first reaction liquid be controlled appropriately. Specifically, the surface tension of the reaction liquid at 25° C. is preferably 15 mN/m or more to 60 mN/m or less, more preferably 20 mN/m or more to 60 mN/m or less, and still more preferably 20 mN/m or more to 45 mN/m or less. In particular, the surface tension is preferably 25 mN/m or more to 45 mN/m or less. In this specification, the surface tension of the ink (first and second inks) and the surface tension of the reaction liquid (first and second reaction liquids) are “static surface tensions” measured by Wilhelmy plate method. The surface tensions of the ink and the reaction liquid can be determined as static surface tension using, for example, a surface tensiometer using the Wilhelmy method (Automatic surface tensiometer CBVP-Z (trade name) available from Kyowa Interface Science Co., Ltd.).

The viscosity of the reaction liquid at 25° C. is preferably 1.0 mPa·s or more to 10.0 mPa·s or less. The pH of the reaction liquid at 25° C. is preferably 5.0 or more to 9.5 or less, more preferably 6.0 or more to 9.0 or less.

### Second Reaction Liquid

The recording method of the present disclosure includes a second reaction liquid applying step of applying a second reaction liquid, which is an aqueous reaction liquid containing a reactant that reacts with at least one aqueous ink selected from the group consisting of the first ink and the second ink, to a recording medium. Hereinafter, components of the second reaction liquid will be described in detail.

### Reactant

The second reaction liquid, which reacts with the ink when coming into contact with the ink and aggregates the components in the ink (components having an anionic group such as a resin, a surfactant and a self-dispersing pigment), contains a reactant. Due to the presence of the reactant, when the ink comes into contact with the reactant on the recording medium, the existential state of the component having an anionic group in the ink is destabilized, promoting ink aggregation. Examples of the reactant include a cationic component, such as a polyvalent metal ion and a cationic resin, and an organic acid. Among them, the second reaction liquid preferably contains a polyvalent metal salt. The reactants may be used either alone or in combination.

The polyvalent metal salt content (% by mass) of the second reaction liquid is preferably 1.0% by mass or more to 20.0% by mass or less based on the total mass of the reaction liquid. In this specification, the “polyvalent metal salt content (% by mass)” of the reaction liquid when the polyvalent metal salt is hydrate means the “anhydrous polyvalent metal salt content (% by mass)” excluding water as hydrate.

Examples of the polyvalent metal ion, which constitutes a polyvalent metal salt, include divalent metal ions such as Ca²⁺, Cu²⁺, Ni²⁺, Mg²⁺, Sr²⁺, Ba²⁺ and Zn²⁺ and trivalent metal ions, such as Fe³⁺, Cr³⁺, Y³⁺ and Al³⁺. To add a polyvalent metal ion to the reaction liquid, a water-soluble polyvalent metal salt (which may be a hydrate) in which a polyvalent metal ion and an anion are combined can be used. Examples of the anion include inorganic anions such as Cl⁻, Br⁻, I⁻, ClO⁻, ClO₂⁻, ClO₃⁻, ClO₄⁻, NO₂⁻, NO₃⁻, SO₄²⁻, CO₃²⁻, HCO₃⁻, PO₄³⁻, HPO₄²⁻ and H₂PO₄⁻ and organic anions such as HCOO⁻, (COO⁻)₂, COOH(COO⁻), CH₃COO⁻, CH₃CH(OH)COO⁻, C₂H₄ (COO⁻)₂, C₆H₅COO⁻, C₆H₄(COO⁻)₂ and CH₃SO₃⁻.

As the reactant in the second reaction liquid, magnesium sulfate is preferred among the polyvalent metal salts. In other words, the polyvalent metal salt in the second reaction liquid is preferably magnesium sulfate. This is because the aggregation speed of solid components of the ink, such as particulate component, can be readily adjusted by the reactant content of the reaction liquid and the application amount of the reaction liquid. When the reactant is magnesium sulfate, the magnesium sulfate content (% by mass) of the second reaction liquid is preferably 1.0% by mass or more to 15.0% by mass or less, and 2.0% by mass or more to 10.0% by mass or less, based on the total mass of the reaction liquid. The magnesium sulfate content (% by mass) of the second reaction liquid is preferably 0.8 times or more to 3.5 times or less, more preferably 1.5 times or more to 3.5 times or less the magnesium sulfate content (% by mass) of the first reaction liquid.

As mentioned above, the reactants may be used either alone or in combination. It is preferable that the second reaction liquid further contain a cationic resin to enhance the aggregation power of the ink. The cationic resin content (% by mass) of the second reaction liquid is preferably 0.1% by mass or more to 10.0% by mass or less, more preferably 0.2% by mass or more to 5.0% by mass or less, based on the total mass of the reaction liquid. In particular, the cationic resin content is particularly preferably 0.5% by mass or more to 5.0% by mass or less.

Examples of the cationic resin include a resin having a primary to tertiary amine structure and a resin having a quaternary ammonium salt structure. Specific examples include resins having structures of vinylamine, allylamine, vinylimidazole, vinylpyridine, dimethylaminoethyl methacrylate, ethyleneimine, guanidine, diallyldimethylammonium chloride and alkylamine-epichlorohydrin condensation. In order to improve solubility in the reaction liquid, the cationic resin may be used in combination with an acidic compound, or the cationic resin may be subjected to quaternarization treatment.

The reaction liquid containing an organic acid has a buffer capacity in an acidic region (less than pH 7.0, preferably pH 2.0 to pH 5.0), efficiently making the anionic group of the component in an ink be in an acid form and causing the component to aggregate. Examples of the organic acid include monocarboxylic acids such as formic acid, acetic acid, propionic acid, butyric acid, benzoic acid, glycolic acid, lactic acid, salicylic acid, pyrrole carboxylic acid, furan carboxylic acid, picolinic acid, nicotinic acid, thiophene carboxylic acid, levulinic acid and coumaric acid and salts thereof, dicarboxylic acids such as oxalic acid, malonic acid, succinic acid, glutaric acid, adipic acid, maleic acid, fumaric acid, itaconic acid, sebacic acid, phthalic acid, malic acid and tartaric acid and salts and hydrogen salts thereof, tricarboxylic acids such as citric acid and trimellitic acid and salts and hydrogen salts thereof, tetracarboxylic acids such as pyromellitic acid and salts and hydrogen salts thereof. When the reactant is an organic acid, the organic acid content (% by mass) of the second reaction liquid is preferably 1.0% by mass or more to 50.0% by mass or less, based on the total mass of the reaction liquid.

### Aqueous Medium

The second reaction liquid is an aqueous reaction liquid containing at least water as an aqueous medium. The aqueous medium included in the reaction liquid can be the same as that exemplified below as the aqueous medium that can be contained in the ink. A water-soluble organic solvent content (% by mass) of the second reaction liquid is preferably 25.0% mass or less, more preferably 10.0% by mass or less, still more preferably 5.0% by mass or less, based on the total mass of the reaction liquid. The water-soluble organic solvent content (% by mass) of the second reaction liquid may be 0.0% by mass. In other words, the second reaction liquid may contain virtually no water-soluble organic solvent. When the water-soluble organic solvent content is within the above range, the proportion of water in the second reaction liquid increases as the amount of water-soluble organic solvent decreases. This is likely to increase the dynamic surface tension, making it more difficult for the second reaction liquid to wet and spread when applied on the layer of the first ink. This results in further reduction of blur of the second ink, further improving image sharpness. When the first ink contains resin particle, the minimum film forming temperature of the resin particle can be lowered by using less water-soluble organic solvent. This softens the layer of the first ink and reduces image blur. The water content (% by mass) of the second reaction liquid is preferably 50.0% by mass or more to 95.0% by mass or less, based on the total mass of the reaction liquid.

### Other Components

The second reaction liquid may contain various other components as needed. Examples of the other components may be the same as those exemplified below as other components that can be contained in the ink. However, a surfactant should not be included in the water-soluble organic solvent.

### Physical Properties of Reaction Liquid

The second reaction liquid is an aqueous reaction liquid applicable to the ink jet system. Thus, in view of reliability, it is preferable that the physical properties of the first reaction liquid be controlled appropriately. Specifically, the surface tension of the reaction liquid at 25° C. is preferably 15 mN/m or more to 60 mN/m or less, more preferably 20 mN/m or more to 60 mN/m or less, and still more preferably 20 mN/m or more to 45 mN/m or less. In particular, the surface tension is preferably 25 mN/m or more to 60 mN/m or less. The surface tension of the second reaction liquid must be higher than that of the first reaction liquid. In particular, the difference between the surface tension of the second reaction liquid and that of the first reaction liquid is preferably 0.5 mN/m or more to 15.0 mN/m or less, more preferably 2.0 mN/m or more to 15.0 mN/m or less. The viscosity of the reaction liquid at 25° C. is preferably 1.0 mPa·s or more to 10.0 mPa·s or less. The pH of the reaction liquid at 25° C. is preferably 5.0 or more to 9.5 or less, more preferably 6.0 or more to 9.0 or less.

### First Ink

The first ink used in the recording method of the present disclosure is an aqueous ink jet ink containing at least one particulate component selected from the group consisting of a pigment and a resin particle. In other words, the first ink may contain a resin particle without pigments. Such ink is also called clear ink. Hereinafter, components of the first ink will be described in detail.

### Particulate Component

The first ink contains at least one particulate component selected from the group consisting of a pigment and a resin particle. Examples of a resin particle as particulate component include a resin particle formed of, for example, an acrylic resin, a urethane resin and an olefin resin, and a wax particle. The particulate component content (% by mass) of the first ink is preferably 8.0% by mass or more, based on the total mass of the ink. The particulate component content of 8.0% by mass or more increases pores formed by the pigment or the resin particle, increasing the capillary force acting on the second ink. Thus, the sharpness of the image can be improved. The particulate component content (% by mass) of the first ink is preferably 40.0% by mass or less, more preferably 30.0% by mass or less.

### Pigment

The particulate component in the first ink may be a pigment. The pigment content (% by mass) of the ink is preferably 0.1% by mass or more to 20.0% by mass or less, more preferably 0.5% by mass or more to 20.0% by mass or less, still more preferably 0.2% by mass or more to 15.0% by mass or less, based on the total mass of the ink. In particular, the pigment content is preferably 1.0% by mass or more to 15.0% by mass or less.

Specific examples of the pigment include an inorganic pigment, such as carbon black and titanium dioxide, and an organic pigment, such as azo, phthalocyanine, quinacridone, isoindolinone, imidazolone, diketopyrrolopyrrole and dioxazine. The pigments may be used either alone or in combination.

The pigment may be a resin-dispersed pigment in which a resin is used as a dispersant, or a self-dispersible pigment having a hydrophilic group bonded to the surface of the pigment particle. Furthermore, the pigment may be a resin-bonded pigment in which an organic group including a resin is chemically bonded to the surface of the pigment particle or a microcapsule pigment in which the surface of the pigment particle is coated with a resin or other substances. The above pigments of different dispersion types may be used in combination. In particular, a resin-dispersed pigment in which a resin as a dispersant is physically adsorbed on the surface of the pigment particle is preferably used, rather than a resin-bonded pigment and a microcapsule pigment.

A resin dispersant for dispersing pigments in an aqueous medium is preferably one that can disperse pigments in the aqueous medium by the action of the anionic group. The resin dispersant may be a resin having an anionic group such as resins described below, particularly a water-soluble resin. The pigment content (% by mass) of the ink is preferably 0.3 times or more to 10.0 times or less the resin dispersant content (% by mass).

The self-dispersing pigment may be one in which the anionic group, such as a carboxylic acid group, a sulfonic acid group and a phosphoric acid group is bonded to the particle surface of the pigment directly or through another atomic group (—R—). The anionic group may be in either acid or salt form, and if in salt form, may be either partially dissociated or fully dissociated. When the anionic group is in salt form, examples of the cation that serves as a counter ion include an alkali metal cation, ammonium and organic ammonium. Specific examples of the atomic group (—R—) include a linear or branched alkylene group having 1 to 12 carbon atoms, an arylene group, such as a phenylene group and a naphthylene group, a carbonyl group, an imino group, an amide group, a sulfonyl group, an ester group and an ether group. The atomic group (—R—) may also be a combination of these groups.

The pigment as a particulate component in the first ink is preferably titanium dioxide. Titanium dioxide has a relatively high surface free energy, increasing the capillary force acting on the second ink, which will be described below. This can further reduce the possibility that the second ink will blur.

An inorganic oxide such as titanium dioxide reacts with a water molecule constituting the aqueous medium in an aqueous ink to produce a hydroxy group on its surface (hereinafter may be referred to as “surface hydroxy group”). In view of this, it is common for an aqueous ink for ink jet printing to be surface treated with an inorganic oxide such as alumina and silica while using the produced surface hydroxy group to further improve the preservation stability of the ink. The surface hydroxy group of the titanium dioxide particle has properties specific to the inorganic oxide corresponding to the inorganic compound used for the surface treatment and has a different isoelectric point depending on the type of inorganic compound, which is an indicator of strength as an acid. Therefore, although titanium dioxide itself is an inorganic oxide, the surface of the titanium dioxide particle exhibits the properties of an inorganic oxide corresponding to the inorganic compound used for surface treatment, and the surface charge of the titanium dioxide particle strongly depends on the pH of the aqueous medium, type of surface treatment agent and the amount of surface treatment agent used.

Titanium dioxide is a white pigment and exists in three crystal forms: rutile, anatase and brookite. Among them, a rutile titanium dioxide is preferred. Examples of the processes for industrial production of titanium dioxide include the sulfate process and the chloride process, and the titanium dioxide used in the present disclosure may be produced by either method.

Titanium dioxide may be surface coated (surface treated) with inorganic oxide or organic component. In particular, titanium dioxide surface-treated with alumina and silica is preferred. The surface treatment is expected to suppress photocatalytic activity and improve dispersibility. In this specification, “alumina” is a general term for an oxide of aluminum, such as aluminum oxide. In this specification, “silica” is a general term for silicon dioxide or a substance composed of silicon dioxide. Most of alumina and silica coating titanium dioxide are present in the form of silicon dioxide and aluminum oxide.

A method for measuring the percentage of alumina and silica in titanium dioxide particle, i.e., the amount of alumina and silica coating the titanium dioxide, is, for example, quantitative analysis of aluminum and silicon elements by inductively coupled plasma (ICP) atomic emission spectroscopy. In this method, the percentage can be calculated by assuming that all atoms coating the surface are oxides and converting the obtained values of aluminum and silicon to their oxides, i.e., alumina and silica.

Examples of the surface treatment method for titanium dioxide include a wet treatment and a dry treatment. For example, after titanium dioxide is dispersed in a liquid medium, surface treatment may be performed by reacting it with a surface treatment agent such as sodium aluminate and sodium silicate. The desired properties can be provided by changing the ratio of the surface treatment agent as needed. Other than alumina and silica, inorganic oxides such as zinc oxide and zirconia and organic components such as polyol can be used for the surface treatment without degrading the effects of the present disclosure.

### Resin

The first ink may contain a resin. The particulate component of the first ink may be a resin particle. The first ink may contain a water-soluble resin that can dissolve in an aqueous medium. A resin can be added to the ink (i) to stabilize dispersed state of a pigment, i.e., as a resin dispersant or a dispersant aid or (ii) to improve various properties of the recorded images. Hereinafter, a water-soluble resin and a resin particle as a particulate component may be collectively referred to as a “resin.”

The resin content (% by mass) of the first ink is preferably 0.1% by mass or more to 20.0% by mass or less, more preferably 0.5% by mass or more to 15.0% by mass or less, based on the total mass of the ink. The resin may be a block copolymer, a random copolymer, a graft copolymer or a combination thereof. When a resin particle is used as the particulate component, the resin particle content (% by mass) of the first ink is preferably 0.1% by mass or more to 15.0% by mass or less, more preferably 1.0% by mass or more to 10.0% by mass or less, based on the total mass of the ink. The resins may be used either alone or in combination.

### Composition of Resin

Examples of the resin include an acrylic resin, a urethane resin and an olefin resin. Among them, an acrylic resin and a urethane resin are preferable, and an acrylic resin composed of a unit derived from (meth)acrylic acid or (meth)acrylate is further preferable.

The acrylic resin is preferably a resin having a hydrophilic unit and a hydrophobic unit as constitution units. In particular, a resin preferably has a hydrophilic unit derived from (meth)acrylic acid and a hydrophobic unit derived from at least one monomer having an aromatic ring or (meth)acrylic acid ester monomer. In particular, a resin preferably has a hydrophilic unit derived from (meth)acrylic acid and a hydrophobic unit derived from a monomer of at least one of styrene and α-methylstyrene. These resins, which are likely to interact with pigments, can be suitably used as resin dispersants to disperse pigments.

The hydrophilic unit has a hydrophilic group such as an anionic group. The hydrophilic unit can be formed, for example, through polymerization of a hydrophilic monomer having a hydrophilic group. Specific examples of the hydrophilic monomer having a hydrophilic group include acidic monomers having a carboxy group, such as (meth)acrylic acid, itaconic acid, maleic acid and fumaric acid and anionic monomers such as anhydrides and salts of these acidic monomers. Examples of the cation constituting the salt of an acidic monomer include a lithium ion, a sodium ion, a potassium ion, an ammonium ion and an organic ammonium ion. The hydrophobic unit does not have a hydrophilic group such as an anionic group. The hydrophobic unit can be formed, for example, through polymerization of a hydrophobic monomer not having a hydrophilic group. Specific examples of the hydrophobic monomer include monomers having an aromatic ring, such as styrene, α-methylstyrene and benzyl (meth)acrylate, and (meth)acrylic ester monomers, such as methyl (meth)acrylate, butyl (meth)acrylate and 2-ethylhexyl (meth)acrylate.

A urethane resin can be produced, for example, through reaction between polyisocyanate and polyol. A chain extender may further be reacted. Examples of the olefin resin include polyethylene and polypropylene.

### Resin Properties

In this specification, “the resin is water-soluble” means that, when the resin is neutralized with an equivalent amount of an alkali to the acid value, the resin is present in an aqueous medium without forming such a particle whose diameter can be measured by dynamic light scattering. Whether the resin is water-soluble or not can be determined in accordance with the following method. First, a liquid (resin solid content: 10% by mass) containing a resin neutralized by an alkali (such as sodium hydroxide and potassium hydroxide) equivalent to the acid value is provided. Next, the prepared liquid is diluted 10 times (on a volumetric basis) with pure water to prepare a sample solution. Then, the particle size of the resin in the sample solution is measured by dynamic light scattering. If there are no particles whose particle diameter can be measured, the resin is determined to be water-soluble. This measurement is performed under conditions of SetZero: 30 seconds, the number of measurements: 3 times and the measurement time: 180 seconds. A particle size distribution analyzer may be a particle size analyzer using dynamic light scattering (for example, “UPA-EX150” (trade name) available from NIKKISO CO., LTD.). The particle size distribution analyzer and the measurement conditions should not be limited to the above.

The acid value of the water-soluble resin is preferably 100 mgKOH/g or more to 250 mgKOH/g or less. The weight average molecular weight of the water-soluble resin is preferably 3,000 or more to 15,000 or less.

The acid value of the resin forming the resin particle is preferably 5 mgKOH/g or more to 100 mgKOH/g or less. The weight average molecular weight of the resin forming the resin particle is preferably 1,000 or more and 3,000,000 or less, more preferably 100,000 or more and 3,000,000 or less. The cumulative 50% particle diameter (D₅₀) of the resin particle on a volumetric basis, as measured by dynamic light scattering, is preferably 50 nm or more to 500 nm or less. The cumulative 50% particle diameter of the resin particle on a volumetric basis is a particle diameter at 50% in the particle diameter cumulative curve when accumulated from the smallest particle diameter based on the total volume of the measured particles. The cumulative 50% particle diameter on a volumetric basis of the resin particle can be determined using the above dynamic light scattering particle size analyzer and the measurement conditions. The glass transition temperature of the resin particle is preferably 40° C. or more to 120° C. or less, more preferably 50° C. or more to 100° C. or less. The glass transition temperature (° C.) of the resin particle can be measured using a differential scanning calorimeter (DSC). The resin particle does not need to encapsulate a coloring component.

### Wax Particle

A particle formed of wax (wax particle) can be used as the particulate component of the first ink. The ink containing a wax particle can further improve the abrasion resistance of the recorded image. Wax in this specification may be a composition including a component other than wax or may be wax itself. The wax particle may be dispersed by a dispersant such as a surfactant and a resin. The waxes may be used either alone or in combination. The wax particle content (% by mass) of the first ink is preferably 0.1% by mass or more to 10.0% by mass or less, more preferably 0.5% by mass or more to 5.0% by mass or less, based on the total mass of the ink. In particular, the wax particle content is preferably 1.0% by mass or more to 5.0% by mass or less.

In a narrow sense of the term, wax is ester of water-insoluble higher primary or secondary alcohol and fatty acid and includes animal and plant waxes but not fats and oils. In a broad sense, wax includes a high-melting point fat, a mineral wax, a petroleum wax and various wax blended products and modified products. In the present disclosure, any wax in the broad sense of the term can be used without restriction. Wax in the broad sense can be classified into natural waxes, synthetic waxes, blended products of these waxes (blended waxes) and modified products of these waxes (modified waxes). Examples of the natural wax include animal waxes, such as beeswax, spermaceti and wool wax (lanolin), plant waxes, such as Japan wax, carnauba wax, sugar cane wax, palm wax, candelilla wax and rice oil wax, mineral waxes, such as montan wax, petroleum-based waxes, such as paraffin wax, microcrystalline wax and petrolatum. Examples of the synthetic waxes include hydrocarbon waxes, such as Fischer-Tropsch wax and polyolefin wax (e.g., polyethylene wax and polypropylene wax). The blended waxes are mixtures of the waxes listed above. Modified waxes are the above listed waxes subjected to modification processes such as oxidation, hydrogenation, alcohol modification, acrylic modification and urethane modification. The waxes may be used either alone or in combination. The wax is preferably at least one selected from the group consisting of microcrystalline wax, Fischer-Tropsch wax, polyolefin wax, paraffin wax and modified or blended products of these. In particular, the wax is more preferably a blended product of several types of waxes, still more preferably a blended product of a petroleum wax and a synthetic wax.

It is preferable that the wax be solid at room temperature (25° C.). The melting point (° C.) of the wax is preferably 40° C. or more to 120° C. or less, more preferably 50° C. or more to 100° C. or less. The melting point of wax can be measured in accordance with the test method described in 5.3.1 (Melting point test method) of JIS K2235: 1991 (Petroleum waxes). When microcrystalline wax, petrolatum or a mixture of multiple types of wax is used, the melting point can be more accurately measured in accordance with the test method described in 5.3.2. The melting point of wax is easily influenced by characteristics such as a molecular weight (the larger the molecular weight, the higher the melting point), a molecular structure (a linear chain raises a higher melting point, while a branching structure lowers the melting point), crystallinity (the higher the crystallinity, the higher the melting point) and density (the higher the density, the higher the melting point). Controlling these characteristics allows the wax to have a desired melting point. The melting point of wax in an ink can be determined in accordance with the above test method, for example, by using wax that is separated from ink by ultracentrifugation and then washed and dried.

### Aqueous Medium

The first ink used in the recording method of the present disclosure is an aqueous ink containing at least water as the aqueous medium. The first ink can contain water or an aqueous medium that is a mixed solvent of water and a water-soluble organic solvent. As the water, deionized water or ion-exchanged water is preferably used. The water content (% by mass) of the first ink is preferably 50.0% by mass or more to 95.0% by mass or less, based on the total mass of the ink. The water-soluble organic solvent content (% by mass) of the first ink is preferably 2.0% by mass or more to 40.0% by mass or less, based on the total mass of the ink. As the water-soluble organic solvent, any solvent that can be used in the ink jet ink, such as alcohols, (poly)alkylene glycols, glycol ethers, nitrogen-containing solvents and sulfur-containing solvents may be used. The water-soluble organic solvents may be used either alone or in combination.

### Other Components

The first reaction liquid may contain various other components as needed. Examples of the other components include various additives, such as an antifoaming agent, a surfactant, a pH adjuster, a viscosity modifier, an antirust, a preservative, a fungicide, an oxidation inhibitor and a reduction inhibitor. However, the first ink preferably does not contain any reactant contained in the reaction liquid.

### Physical Properties of Ink

The first ink is an aqueous ink applicable to the ink jet system. Thus, in view of reliability, it is preferable that the physical properties of the first reaction liquid be controlled appropriately. Specifically, the surface tension of the ink at 25° C. is preferably 20 mN/m or more to 60 mN/m or less. Furthermore, the viscosity of the ink at 25° C. is preferably 1.0 mPa·s or more to 10.0 mPa·s or less. The pH of the ink at 25° C. is preferably 7.0 or more to 9.5 or less, more preferably 8.0 or more to 9.5 or less.

### Second Ink

The second ink used in the recording method of this disclosure is an aqueous ink jet ink containing a pigment. Hereinafter, components of the second ink will be described in detail.

### Coloring Component

The second ink contains a pigment as a coloring component. The pigment content (% by mass) of the ink is preferably 0.1% by mass or more to 20.0% by mass or less, more preferably 0.2% by mass or more to 20.0% by mass or less, still more preferably 1.0% by mass or more to 15.0% by mass or less, based on the total mass of the ink.

Specific examples of the pigment include an inorganic pigment, such as carbon black and titanium dioxide, and an organic pigment, such as azo, phthalocyanine, quinacridone, isoindolinone, imidazolone, diketopyrrolopyrrole and dioxazine. The pigments may be used either alone or in combination. Among them, the pigment of the second ink is preferably at least one selected from the group consisting of carbon black and an organic pigment. This is because the relatively low surface free energy of the above pigments increases the capillary force acting on the second ink.

The pigment may be a resin-dispersed pigment in which a resin is used as a dispersant, or a self-dispersible pigment having a hydrophilic group bonded to the surface of the pigment particle. Furthermore, the pigment may be a resin-bonded pigment in which an organic group including a resin is chemically bonded to the surface of the pigment particle or a microcapsule pigment in which the surface of the pigment particle is coated with a resin or other substances. The above pigments of different dispersion types may be used in combination. In particular, a resin-dispersed pigment in which a resin as a dispersant is physically adsorbed on the surface of the pigment particle is preferably used, rather than a resin-bonded pigment and a microcapsule pigment.

A resin dispersant for dispersing pigments in an aqueous medium is preferably one that can disperse pigments in the aqueous medium by the action of anionic groups. The resin dispersant may be a resin having an anionic group such as resins described below, particularly a water-soluble resin. The pigment content (% by mass) of the ink is preferably 0.3 times or more to 10.0 times or less the resin dispersant content (% by mass).

The self-dispersing pigment may be one in which the anionic group, such as a carboxylic acid group, a sulfonic acid group and a phosphoric acid group is bonded to the particle surface of the pigment directly or through another atomic group (—R—). The anionic group may be in either acid or salt form, and if in salt form, may be either partially dissociated or fully dissociated. When the anionic group is in salt form, examples of the cation that serves as a counter ion include an alkali metal cation, ammonium and organic ammonium. Specific examples of the atomic group (—R—) include a linear or branched alkylene group having 1 to 12 carbon atoms, an arylene group, such as a phenylene group and a naphthylene group, a carbonyl group, an imino group, an amide group, a sulfonyl group, an ester group and an ether group. The atomic group (—R—) may also be a combination of these groups.

### Resin

The second ink may contain a resin. A resin can be added to the ink (i) to stabilize dispersed state of a pigment, i.e., as a resin dispersant or a dispersant aid or (ii) to improve various properties of the recorded images.

The resin content (% by mass) of the second ink is preferably 0.1% by mass or more to 20.0% by mass or less, more preferably 0.5% by mass or more to 15.0% by mass or less, based on the total mass of the ink. The resin may be a block copolymer, a random copolymer, a graft copolymer or a combination thereof. The resins may be used either alone or in combination.

The resin can be selected from the examples listed as resins that can be used in the first ink. The properties can also be determined in the same manner as those of the examples listed as resins that can be used in the first ink.

### Wax Particle

The second ink may contain a particle formed of wax (wax particle). The ink containing a wax particle can further improve the abrasion resistance of the recorded image. Wax in this specification may be a composition including a component other than wax or may be wax itself. The wax particle may be dispersed by a dispersant such as a surfactant and a resin. The waxes may be used either alone or in combination. The wax particle content (% by mass) of the second ink is preferably 0.1% by mass or more to 10.0% by mass or less, more preferably 0.5% by mass or more to 5.0% by mass or less, based on the total mass of the ink. In particular, the wax particle content is preferably 1.0% by mass or more to 5.0% by mass or less.

The wax can be selected from the examples listed as waxes that can be used in the first ink. The properties can also be determined in the same manner as those of the examples listed as resins that can be used in the first ink.

### Aqueous Medium

The second ink used in the recording method of the present disclosure is an aqueous ink containing at least water as the aqueous medium. The second ink can contain water or an aqueous medium that is a mixed solvent of water and a water-soluble organic solvent. As the water, deionized water or ion-exchanged water is preferably used. The water content (% by mass) of the second ink is preferably 50.0% by mass or more to 95.0% by mass or less, based on the total mass of the ink. The water-soluble organic solvent content (% by mass) of the second ink is preferably 2.0% by mass or more to 40.0% by mass or less, based on the total mass of the ink. The water-soluble organic solvent in the second ink can be selected from the examples listed as water-soluble organic solvents that can be used in the first ink. The water-soluble organic solvents may be used either alone or in combination.

### Other Components

The second ink may contain various other components as needed. Examples of the other components include various additives, such as an antifoaming agent, a surfactant, a pH adjuster, a viscosity modifier, an antirust, a preservative, a fungicide, an oxidation inhibitor and a reduction inhibitor. However, the second ink preferably does not contain any reactant contained in the reaction liquid.

### Physical Properties of Ink

The second ink is an aqueous ink applicable to the ink jet system. Thus, in view of reliability, it is preferable that the physical properties of the first reaction liquid be controlled appropriately. Specifically, the surface tension of the ink at 25° C. is preferably 20 mN/m or more to 60 mN/m or less. Furthermore, the viscosity of the ink at 25° C. is preferably 1.0 mPa·s or more to 10.0 mPa·s or less. The pH of the ink at 25° C. is preferably 7.0 or more to 9.5 or less, more preferably 8.0 or more to 9.5 or less.

For easy control of the wet spreading of the second ink on the first ink, the difference between the surface tension γ1 of the first ink and the surface tension γ2 of the second ink (γ2−γ1) is preferably −15.0 mN/m or more to 15.0 mN/m or less. More preferably, the difference is 2.0 mN/m or more to 15.0 mN/m or less.

### EXAMPLES

Hereinafter, the present disclosure will be described in more detail by way of examples and comparative examples, but the present disclosure should not be limited to the examples described below without departing from the scope of the disclosure. It should be noted that, in the description of the amounts of components, “part(s)” and “%” are by mass unless otherwise specified.

### Preparation of Reaction Liquid

Components (%) indicated in the upper section in Tables 1 to 3 are mixed and thoroughly stirred and then pressure-filtered through a cellulose acetate filter having a pore size of 3.0 μm (available from ADVANTEC CO., LTD.) to prepare first and second reaction liquids. In Tables 1 to 3, “Catiomaster PDT-2” is the trade name for an aqueous solution of amine-epichlorohydrin condensation polymer (cationic resin content: 60.0%) available from Yokkaichi Chemical Company Limited. “Catiomaster PD-7” is the trade name for an aqueous solution of epichlorohydrin condensation polymer (cationic resin content: 50.0%) available from Yokkaichi Chemical Company Limited. “ACETYLENOL E100” is the trade name for a nonionic surfactant available from Kawaken Fine Chemicals Co., Ltd. “BYK348” is the trade name for a silicone surfactant available from BYK. “Proxel GXL(S)” is the trade name for a preservative available from Arch Chemicals, Inc. In Tables 1 and 2, surface tensions are indicated in the lower section. The surface tensions were measured using a surface tensiometer using the Wilhelmy method (Automatic Surface Tension Tester CBVP-Z (trade name) available from Kyowa Interface Science Co., Ltd.) at 25° C.

TABLE 1
Compositions and Properties of First Reaction Liquid

| | First Reaction Liquid | | | | | | | | | |
|---|---|---|---|---|---|---|---|---|---|---|
| | 1 | 2 | 3 | 4 | 5 | 6 | 7 | 8 | 9 | 10 |
| Magnesium Sulfate, | 4.0 | 4.0 | 4.0 | | | 4.0 | 4.0 | 4.0 | | 0.4 |
| 7-hydrate | | | | | | | | | | |
| Barium Nitrate | | | | | 4.0 | | | | | |
| Catiomaster PDT-2 | 1.7 | 1.7 | 1.7 | 1.7 | 1.7 | | 1.7 | 1.7 | | |
| Catiomaster PD-7 | | | | | | | | | 4.0 | |
| 1,2-Butanediol | 15.0 | 15.0 | 15.0 | 15.0 | 15.0 | 15.0 | 15.0 | | | |
| 1,4-Butanediol | | | | | | | | | 1.0 | |
| 2-Pyrrolidone | | | | | | | | | 30.0 | |
| 3-Methyl-1,5- | | | | | | | | | 2.0 | |
| pentanediol | | | | | | | | | | |
| 1,2-Hexanediol | | | | | | | | | | 3.0 |
| Propylene Glycol | | | | | | | | | | 18.0 |
| ACETYLENOL | 1.7 | 1.3 | 2.1 | 1.7 | 1.7 | 1.7 | 0.3 | 0.8 | | |
| E100 | | | | | | | | | | |
| BYK348 | | | | | | | | | 1.0 | 0.6 |
| Proxel GXL(S) | 0.2 | 0.2 | 0.2 | 0.2 | 0.2 | 0.2 | 0.2 | 0.2 | 0.2 | 0.2 |
| Ion Exchanged Water | 77.4 | 77.8 | 77.0 | 81.4 | 77.4 | 79.1 | 78.8 | 93.3 | 61.8 | 77.8 |
| Surface Tension | 24 | 25 | 23 | 24 | 24 | 24 | 28 | 27 | 22 | 22 |
| (mN/m) | | | | | | | | | | |

TABLE 2
Compositions and Properties of Second Reaction Liquid

| | Second Reaction Liquid | | | | | | |
|---|---|---|---|---|---|---|---|
| | 1 | 2 | 3 | 4 | 5 | 6 | 7 |
| Magnesium Sulfate, | 4.0 | 4.0 | 4.0 | 4.0 | 4.0 | 4.0 | |
| 7-hydrate | | | | | | | |
| Barium Nitrate | | | | | | | |
| Malic Acid | | | | | | | |
| Catiomaster PDT-2 | 1.7 | 1.7 | 1.7 | 1.7 | 1.7 | 1.7 | 1.7 |
| Catiomaster PD-7 | | | | | | | |
| 1,2-Butanediol | | | | 1.0 | 25.0 | 26.0 | |
| 1,4-Butanediol | | | | | | | |
| 2-Pyrrolidone | | | | | | | |
| 3-Methyl-1,5- | | | | | | | |
| pentanediol | | | | | | | |
| 1,2-Hexanediol | | | | | | | |
| Propylene Glycol | | | | | | | |
| ACETYLENOL | 0.4 | 0.8 | 0.3 | 0.4 | 0.4 | 0.4 | 0.5 |
| E100 | | | | | | | |
| BYK348 | | | | | | | |
| Proxel GXL(S) | 0.2 | 0.2 | 0.2 | 0.2 | 0.2 | 0.2 | 0.2 |
| Ion Exchanged Water | 93.7 | 93.3 | 93.8 | 92.7 | 68.7 | 67.7 | 97.6 |
| Water-Soluble Organic | 0.0 | 0.0 | 0.0 | 1.0 | 25.0 | 26.0 | 0.0 |
| Solvent Content (%) | | | | | | | |
| Surface Tension | 28 | 27 | 29 | 28 | 28 | 28 | 28 |
| (mN/m) | | | | | | | |

TABLE 3
Compositions and Properties of Second Reaction Liquid

| | Second Reaction Liquid | | | | | | |
|---|---|---|---|---|---|---|---|
| | 8 | 9 | 10 | 11 | 12 | 13 | 14 |
| Magnesium Sulfate, | | 4.0 | | 4.0 | 4.0 | | 1.0 |
| 7-hydrate | | | | | | | |
| Barium Nitrate | 4.0 | | | | | | |
| Malic Acid | | | 10.0 | | | | |
| Catiomaster PDT-2 | 1.7 | | | 1.7 | 1.7 | | |
| Catiomaster PD-7 | | | | | | 4.0 | |
| 1,2-Butanediol | | | 26.0 | | 15.0 | | |
| 1,4-Butanediol | | | | | | 1.0 | |
| 2-Pyrrolidone | | | | | | 30.0 | |
| 3-Methyl-1,5- | | | | | | 2.0 | |
| pentanediol | | | | | | | |
| 1,2-Hexanediol | | | | | | | 3.0 |
| Propylene glycol | | | | | | | 18.0 |
| ACETYLENOL | 0.4 | 0.4 | 0.4 | 1.8 | 1.3 | | |
| E100 | | | | | | | |
| BYK348 | | | | | | 1.0 | 0.6 |
| Proxel GXL(S) | 0.2 | 0.2 | 0.2 | 0.2 | 0.2 | 0.2 | 0.2 |
| Ion Exchanged Water | 93.7 | 95.4 | 63.4 | 92.3 | 77.8 | 61.8 | 77.2 |
| Water-Soluble Organic | 0.0 | 0.0 | 26.0 | 0.0 | 15.0 | 33.0 | 21.0 |
| Solvent Content (%) | | | | | | | |
| Surface Tension | 28 | 28 | 28 | 24 | 25 | 28 | 22 |
| (mN/m) | | | | | | | |

### Pigment Dispersion Liquid 1

Ion-exchanged water was produced by mixing 40.0 parts of titanium dioxide and 1.2 parts of 3-(methoxy (polyoxyethylene)9-12) propyltrimethoxysilane in such a manner that the total of the components becomes 100.0 parts, and then the mixture was pre-dispersed using a homogenizer. As the titanium dioxide, rutile titanium dioxide (TITANIX JR-403 (trade name) surface treatment: alumina or silica) was used. Then, dispersion treatment was performed using 0.5 mm zirconia beads for 12 hours at 25° C. in a paint shaker. The zirconia beads were filtered out, and an appropriate amount of ion-exchanged water was added as needed to prepare a pigment dispersion liquid 1 having a pigment (titanium dioxide particle) content of 40.0%.

### Pigment Dispersion Liquid 2

A styrene-ethyl acrylate-acrylic acid copolymer (Resin 1) having an acid value of 150 mgKOH/g and a weight average molecular weight of 8,000 was prepared. An aqueous solution of Resin 1 having a resin (resin solid) content of 20.0% was prepared by neutralizing 20.0 parts of Resin 1 with potassium hydroxide equimolar to its acid value and adding an appropriate amount of pure water. A mixture was produced by mixing 20.0 parts of a pigment (carbon black), 30.0 parts of an aqueous solution of Resin 1 and 50.0 parts of pure water. The produced mixture and 200 parts of zirconia beads having a diameter of 0.3 mm were placed in a batch-type vertical sand mill (available from IMEX Co., Ltd.) and dispersed for 5 hours while being cooled by water. After coarse particles were removed by centrifugal separation, the mixture was pressure-filtered through a cellulose acetate filter having a pore size of 3.0 μm (available from ADVANTEC CO., LTD.) to prepare a pigment dispersion liquid 2 having a pigment content of 20.0% and a resin dispersant (Resin 1) content of 6.0%.

### Pigment Dispersion Liquid 3

Pigment dispersion liquid 3 having a pigment content of 20.0% and a resin dispersant content (Resin 1) of 6.0% was prepared by the same procedure as the pigment dispersion liquid 1 described above, except that the pigment was changed to C.I. Pigment Blue 15:3.

### Preparation of Resin Particle

### Resin Particle 1

In a four-necked flask equipped with a stirrer, a reflux cooling device and a nitrogen gas inlet tube, 74.0 parts of ion-exchanged water and 0.2 parts of potassium persulfate were added and mixed. In addition, an emulsion was prepared by mixing 24.0 parts of ethyl methacrylate, 1.5 parts of methacrylic acid and 0.3 parts of reactive surfactant (AQUALON KH-05 (trade name) available from DKS Co. Ltd.). Under a nitrogen atmosphere, the prepared emulsion was dropped into the above four-necked flask over one hour and then subjected to polymerization reaction for two hours at 80° C. while being stirred. After the emulsion was cooled to 25° C., ion-exchanged water and an aqueous solution containing potassium hydroxide equimolar to the acid value of the resin particle were added, and thus an aqueous dispersion liquid of the resin particle 1 having a resin particle content (solid content) of 40.0% was prepared.

### Resin Particle 2

In a four-necked flask equipped with a stirrer, a reflux cooling device and a nitrogen gas inlet tube, 74.0 parts of ion-exchanged water and 0.2 parts of potassium persulfate were added and mixed. In addition, an emulsion was prepared by mixing 21.0 parts of ethyl methacrylate, 1.5 parts of methacrylic acid, 3.0 parts of ethylene glycol dimethacrylate and 0.3 parts of reactive surfactant (AQUALON KH-05 (trade name) available from DKS Co. Ltd.). Under a nitrogen atmosphere, the prepared emulsion was dropped into the above four-necked flask over one hour and then subjected to polymerization reaction for two hours at 80° C. while being stirred. After the emulsion was cooled to 25° C., ion-exchanged water and an aqueous solution containing potassium hydroxide equimolar to the acid value of the resin particle were added, and thus an aqueous dispersion liquid of resin particle 2 having a resin particle content (solid content) of 40.0% was prepared.

### Preparation of Wax Particle

A polyethylene wax (melting point 124° C.), a dispersant and ion-exchanged water were added to a vessel equipped with a stirrer, a thermometer and a temperature controller. The temperature was raised to 160° C., and the mixture was stirred for 2 hours. As the dispersant, a nonionic surfactant (NIKKOL BC-10 (trade name) available from Nikko Chemicals Co., Ltd. Polyoxyethylene Cetyl Ether (number of ethylene oxide groups: 10)) was used. The stirring conditions were adjusted so that the cumulative 50% particle diameter (D₅₀) of the wax particle dispersed by the dispersant was 180 nm on a volume basis. Then, the temperature was lowered to 25° C., and thus an aqueous dispersion liquid of wax particle having a wax particle content (solid content) of 35.0% was prepared.

### Preparation of Ink

Components (%) indicated in the upper section in Tables 4 to 6 were mixed and thoroughly stirred and then pressure-filtered through a cellulose acetate filter having a pore size of 3.0 μm (available from ADVANTEC CO., LTD.) to prepare the first and second inks. For the ink prepared by using a pigment dispersion liquid 3, a cellulose acetate filter having a pore size of 5.0 μm (available from ADVANTEC CO., LTD.) was used. In Tables 4 to 6, “ACETYLENOL E100” is the trade name for a nonionic surfactant available from Kawaken Fine Chemicals Co., Ltd. “BYK348” is the trade name for a silicone surfactant available from BYK. “Proxel GXL(S)” is the trade name for a preservative available from Arch Chemicals, Inc. In Tables 4 to 6, the surface tension was measured at 25° C. using a surface tensiometer using the Wilhelmy method (Automatic Surface Tension Tester CBVP-Z (trade name) available from Kyowa Interface Science Co., Ltd.).

TABLE 4
Compositions and Properties of First Ink

| | First Ink | | | | | | | |
|---|---|---|---|---|---|---|---|---|
| | 1 | 2 | 3 | 4 | 5 | 6 | 7 | 8 |
| Pigment Dispersion Liquid 1 | 37.5 | 15.0 | 37.5 | 37.5 | 37.5 | 10.0 | 17.5 | 12.5 |
| Pigment Dispersion Liquid 2 | | | | | | | | |
| Pigment Dispersion Liquid 3 | | | | | | | | |
| C.I. Direct Blue 199 | | | | | | | | |
| Aqueous Dispersion Liquid | 25.0 | 10.0 | | | 25.0 | 7.5 | | 7.5 |
| of Resin Particle 1 | | | | | | | | |
| Aqueous Dispersion Liquid | | | | 25.0 | | | | |
| of Resin Particle 2 | | | | | | | | |
| Aqueous Dispersion Liquid | | | | | 4.3 | | | |
| of Wax Particle 1 | | | | | | | | |
| 1,2-Butanediol | 15.0 | 15.0 | 15.0 | 15.0 | 15.0 | 15.0 | 15.0 | 15.0 |
| ACETYLENOL E100 | 1.5 | 1.5 | 1.5 | 1.5 | 1.5 | 1.5 | 1.5 | 1.5 |
| Proxel GXL(S) | 0.2 | 0.2 | 0.2 | 0.2 | 0.2 | 0.2 | 0.2 | 0.2 |
| Ion Exchanged Water | 20.8 | 58.3 | 45.8 | 20.8 | 16.5 | 65.8 | 65.8 | 63.3 |
| Pigment Content (P) (%) | 15.0 | 6.0 | 15.0 | 15.0 | 15.0 | 4.0 | 7.0 | 5.0 |
| Resin Particle Content (E) (%) | 10.0 | 4.0 | 0.0 | 10.0 | 11.5 | 3.0 | 0.0 | 3.0 |
| Particulate Component | 25.0 | 10.0 | 15.0 | 25.0 | 26.5 | 7.0 | 7.0 | 8.0 |
| Content (P + E) (%) | | | | | | | | |
| Surface Tension γ₁(mN/m) | 30 | 30 | 30 | 30 | 30 | 30 | 30 | 30 |

TABLE 5
Compositions and Properties of First Ink

| | First Ink | | | | | | | |
|---|---|---|---|---|---|---|---|---|
| | 9 | 10 | 11 | 12 | 13 | 14 | 15 | 16 |
| Pigment Dispersion Liquid 1 | 20.0 | 50.0 | 75.0 | | | | | |
| Pigment Dispersion Liquid 2 | | | | | 25.0 | | | |
| Pigment Dispersion Liquid 3 | | | | | | 25.0 | 20.0 | |
| C.I. Direct Blue 199 | | | | | | | | 4.0 |
| Aqueous Dispersion Liquid | | 25.0 | | 25.0 | 25.0 | 25.0 | 7.5 | |
| of Resin Particle 1 | | | | | | | | |
| Aqueous Dispersion Liquid | | | | | | | | |
| of Resin Particle 2 | | | | | | | | |
| Aqueous Dispersion Liquid | | | | | | | | |
| of Wax Particle | | | | | | | | |
| 1,2-Butanediol | 15.0 | 15.0 | 15.0 | 15.0 | 15.0 | 15.0 | 15.0 | 15.0 |
| ACETYLENOL E100 | 1.5 | 1.5 | 1.5 | 1.5 | 1.5 | 1.5 | 1.5 | 1.5 |
| Proxel GXL(S) | 0.2 | 0.2 | 0.2 | 0.2 | 0.2 | 0.2 | 0.2 | 0.2 |
| Ion Exchanged Water | 63.3 | 8.3 | 8.3 | 58.3 | 33.3 | 33.3 | 55.8 | 79.3 |
| Pigment Content (P) (%) | 8.0 | 20.0 | 30.0 | 0.0 | 5.0 | 5.0 | 4.0 | 0.0 |
| Resin Particle Content (E) (%) | 0.0 | 10.0 | 0.0 | 10.0 | 10.0 | 10.0 | 3.0 | 0.0 |
| Particulate Component | 8.0 | 30.0 | 30.0 | 10.0 | 15.0 | 15.0 | 7.0 | 0.0 |
| Content (P + E) (%) | | | | | | | | |
| Surface Tension γ₁(mN/m) | 30 | 30 | 30 | 30 | 30 | 30 | 30 | 38 |

TABLE 6
Compositions and Properties of Second Ink

| | Second Ink | | |
|---|---|---|---|
| | 1 | 2 | 3 |
| Pigment Dispersion Liquid 1 | | | 37.5 |
| Pigment Dispersion Liquid 2 | | 25.0 | |
| Pigment Dispersion Liquid 3 | 25.0 | | |
| Aqueous Dispersion Liquid of Resin Particle 1 | 40.0 | 40.0 | 40.0 |
| 1,2-Butanediol | 15.0 | 13.0 | 15.0 |
| ACETYLENOL E100 | 1.6 | 1.6 | 1.6 |
| Proxel GXL(S) | 0.2 | 0.2 | 0.2 |
| Ion Exchanged Water | 18.2 | 20.2 | 5.7 |
| Surface Tension γ₂(mN/m) | 30 | 30 | 30 |

### Preparation of Recording Medium

The following recording media were provided:

Recording medium 1: a polyethylene terephthalate (PET) film (PETWH50 PAT8LK (trade name) available from LINTEC SIGN SYSTEM, INC., a water absorption of 2.5 mL/m² for a period of 30 ms^{1/2} from the beginning of contact with water when measured by a Bristow method); the recording medium exhibits a water absorption of 10 mL/m² or less,

Recording medium 2: art paper (Art PW8K (trade name) available from LINTEC SIGN SYSTEM, INC., a water absorption of 9.5 mL/m² for a period of 30 ms^{1/2} from the beginning of contact with water when measured by a Bristow method); and

Recording medium 3: high quality paper (55PW8KCOC (trade name) available from LINTEC SIGN SYSTEM, INC., a water absorption of 12.0 mL/m² for a period of 30 ms^{1/2} from the beginning of contact with water when measured by a Bristow method).

### Evaluations

Cartridges were filled with sets of the first reaction liquid, the second reaction liquid, the first ink and the second ink of types indicated in Table 7. The cartridges were loaded in an ink jet recording apparatus (imagePROGRAF PRO-2000 (trade name) available form CANON KABUSHIKI KAISHA) having a recording head that ejects ink using thermal energy. A heating device that sends air to dry a recording medium that has received the reaction liquid and ink is mounted in the above recording apparatus at a position downstream of the recording head in the transportation direction of the recording medium. Then, the surface temperature of the recording medium was raised to 80° C. by a heating device. Using this recording apparatus, the first reaction liquid and the first ink were applied at a recording duty of 30% and at a recording duty of 300%, respectively, over a 5 cm×5 cm area of each of the recording media indicated in Table 7. The time difference between the application of the first reaction liquid and the application of the first ink was adjusted to 500 milliseconds by controlling the operating speed of the transportation member 1300. Then, after the second reaction liquid is applied at a recording duty of 25% over an area where the first reaction liquid and the first ink were applied in layers, ruled lines having a width corresponding to one dot were recorded using the second ink. In this example, the recording duty of 100% means that an image is recorded under the condition that 3.0 ng of a single ink droplet is applied to a unit area of 1/1200 inch× 1/1200 inch.

In this example, image sharpness was evaluated from two perspectives (line width and raggedness). Line width was evaluated to determine macroscopic image sharpness and to determine the degree of blur in the overall image. Raggedness was evaluated to determine microscopic image sharpness, such as image edges. In the present disclosure, “AA”, “A” and “B” are considered as acceptable levels, and “C” is considered as an unacceptable level, based on the evaluation criteria for each of the following items. The evaluation results are indicated on the right sections in Table 7.

In the section of “Sequence of Steps” in Table 7, “1” to “5” were indicated. The details of the numbers are as follow:
“1” indicates a sequence including, in this order, the first reaction liquid applying step, the first ink applying step, the second reaction liquid applying step and the second ink applying step;
“2” indicates a sequence including, in this order, the first reaction liquid applying step, the first ink applying step, the second ink applying step and the second reaction liquid applying step;
“3” indicates a sequence including, in this order, the first ink applying step and the second ink applying step;
“4” indicates a sequence including, in this order, the first ink applying step, the second reaction liquid applying step and the second ink applying step; and
“5” indicates a sequence including, in this order, the first reaction liquid applying step, the first ink applying step and the second ink applying step.

### Sharpness: Line Width

Using an optical microscope (Axio Imager. Z2 (trade name), available from Carl Zeiss AG), the line widths of the ruled lines recorded with the second ink were measured at 10 points, and the average value was calculated. Then, the line widths were evaluated according to the following evaluation criteria:
“AA” indicates that the line width is 25 μm or less;
“A” indicates that the line width is more than 25 μm to 30 μm or less;
“B” indicates that the line width is more than 30 μm to 35 μm or less; and
“C” indicates that the line width is more than 35 μm.
   The thinner the ruled line, the less likely it is that the second ink applied on the first ink will blur.

### Sharpness: Raggedness

Raggedness values at the boundary between the ruled line recorded with the second ink and the underlying layer (area having the applied first ink) were measured at 10 points, and the average value was calculated. The raggedness value is defined in ISO-13660 and was measured in an edge measurement mode using a handheld image quality analyzer (PIAS-II (trade name) available from Quality Engineering Associates, Inc.). Raggedness was then evaluated according to the following evaluation criteria:
“AA” indicates that the raggedness value is 10 or less;
“A” indicates that the raggedness value is more than 10 and 15 or less;
“B” indicates that the raggedness value is more than 15 and 20 or less; and
“C” indicates that the raggedness value is more than 20.
   The smaller the raggedness value, the less likely it is that the colors of adjacent images will be mixed, i.e., image blur is reduced and image sharpness is higher.

TABLE 7
Evaluation Conditions and Evaluation Results

| | | Evaluation Conditions | | | | | | | | |
|---|---|---|---|---|---|---|---|---|---|---|
| | | Ink and Reaction Liquid Set | | | | | | | | |
| | | First | | Second | | | Number of | | Evaluation Results | |
| | | Reaction | First | Reaction | Second | Sequence | Recording | Recording | Line | |
| | | Liquid | Ink | Liquid | Ink | of Steps | Passes | Medium | Width | Raggedness |
| Examples | 1 | 1 | 1 | 1 | 1 | 1 | 8 | 1 | AA | AA |
| | 2 | 1 | 1 | 1 | 1 | 1 | 1 | 1 | AA | AA |
| | 3 | 2 | 1 | 2 | 1 | 1 | 8 | 1 | AA | AA |
| | 4 | 3 | 1 | 3 | 1 | 1 | 8 | 1 | AA | AA |
| | 5 | 1 | 1 | 1 | 2 | 1 | 8 | 1 | AA | AA |
| | 6 | 1 | 2 | 1 | 1 | 1 | 8 | 1 | AA | AA |
| | 7 | 1 | 3 | 1 | 1 | 1 | 8 | 1 | AA | AA |
| | 8 | 1 | 4 | 1 | 1 | 1 | 8 | 1 | AA | AA |
| | 9 | 1 | 5 | 1 | 1 | 1 | 8 | 1 | A | AA |
| | 10 | 1 | 1 | 1 | 1 | 2 | 8 | 1 | B | A |
| | 11 | 1 | 6 | 1 | 1 | 1 | 8 | 1 | B | A |
| | 12 | 1 | 7 | 1 | 1 | 1 | 8 | 1 | B | A |
| | 13 | 1 | 8 | 1 | 1 | 1 | 8 | 1 | AA | AA |
| | 14 | 1 | 9 | 1 | 1 | 1 | 8 | 1 | AA | AA |
| | 15 | 1 | 10 | 1 | 1 | 1 | 8 | 1 | AA | AA |
| | 16 | 1 | 11 | 1 | 1 | 1 | 8 | 1 | AA | AA |
| | 17 | 1 | 12 | 1 | 1 | 1 | 8 | 1 | AA | AA |
| | 18 | 1 | 13 | 1 | 1 | 1 | 8 | 1 | A | A |
| | 19 | 1 | 14 | 1 | 3 | 1 | 8 | 1 | B | B |
| | 20 | 1 | 1 | 4 | 1 | 1 | 8 | 1 | AA | AA |
| | 21 | 1 | 1 | 5 | 1 | 1 | 8 | 1 | AA | AA |
| | 22 | 1 | 1 | 6 | 1 | 1 | 8 | 1 | A | AA |
| | 23 | 4 | 1 | 1 | 1 | 1 | 8 | 1 | AA | B |
| | 24 | 1 | 1 | 7 | 1 | 1 | 8 | 1 | AA | B |
| | 25 | 5 | 1 | 1 | 1 | 1 | 8 | 1 | AA | A |
| | 26 | 1 | 1 | 8 | 1 | 1 | 8 | 1 | AA | A |
| | 27 | 6 | 1 | 1 | 1 | 1 | 8 | 1 | AA | A |
| | 28 | 1 | 1 | 9 | 1 | 1 | 8 | 1 | AA | A |
| | 29 | 1 | 15 | 10 | 3 | 2 | 8 | 1 | B | B |
| | 30 | 1 | 1 | 1 | 2 | 1 | 8 | 2 | AA | AA |
| Comparative | 1 | — | 1 | — | 1 | 3 | 8 | 1 | C | C |
| Examples | 2 | — | 1 | 1 | 1 | 4 | 8 | 1 | C | C |
| | 3 | 1 | 1 | — | 1 | 5 | 8 | 1 | C | C |
| | 4 | 2 | 16 | 2 | 1 | 1 | 8 | 1 | C | B |
| | 5 | 1 | 1 | 11 | 1 | 1 | 8 | 1 | C | B |
| | 6 | 7 | 1 | 11 | 1 | 1 | 8 | 1 | C | B |
| | 7 | 2 | 1 | 12 | 1 | 1 | 8 | 1 | C | B |
| | 8 | 8 | 1 | 2 | 1 | 1 | 8 | 1 | C | B |
| | 9 | 9 | 1 | 13 | 1 | 1 | 8 | 1 | C | B |
| | 10 | 10 | 1 | 14 | 1 | 1 | 8 | 1 | C | B |
| Reference | 1 | 2 | 1 | 2 | 1 | 1 | 8 | 3 | AA | AA |
| [symbol] | 2 | 9 | 1 | 11 | 1 | 1 | 8 | 3 | AA | AA |

[symbol]

indicates data missing or illegible when filed

The results of the raggedness evaluation of reference examples 1 and 2 were “AA”, which is the same as that of Example 1, but Example 1 was better than reference examples 1 and 2.

The present disclosure can provide an ink jet recording method that can record images having high sharpness even when inks are applied in layers on a less- or non-absorbent recording medium. This disclosure further can provide an ink jet recording apparatus used for the ink jet recording method and an aqueous ink.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2023-139411, filed on Aug. 30, 2023 and the benefit of Japanese Patent Application No. 2024-128715, filed on Aug. 5, 2024, which are hereby incorporated by reference herein in their entirety.

What is claimed is:

1. An ink jet recording method comprising ejecting:
a first ink that is an aqueous ink comprising at least one particulate component selected from the group consisting of a pigment and a resin particle;
a second ink that is an aqueous ink comprising a pigment;
a first reaction liquid that is an aqueous reaction liquid comprising a reactant that reacts with at least one selected from the group consisting of the first ink and the second ink; and
a second reaction liquid that is an aqueous reaction liquid comprising a reactant that reacts with at least one selected from the group consisting of the first ink and the second ink,
from a recording head to a recording medium to overlap each other in at least an area of the recording medium to form an image, wherein the method includes:
a first reaction liquid applying step of applying the first reaction liquid to the recording medium;
a first ink applying step of applying the first ink to the recording medium after the first reaction liquid applying step;
a second ink applying step of applying the second ink to the recording medium after the first reaction liquid applying step; and
a second reaction liquid applying step of applying the second reaction liquid to the recording medium after the first reaction liquid applying step,
the recording medium exhibits a water absorption of 10 mL/m² or less for a period of 30 ms^{1/2} from the beginning of contact with water when measured by a Bristow method, and
the second reaction liquid has a higher surface tension than the first reaction liquid.

2. The ink jet recording method according to claim 1, wherein the method comprises, in this order, the first reaction applying step, the first ink applying step, the second reaction liquid applying step and the second ink applying step.

3. The ink jet recording method according to claim 1, wherein a particulate component content (% by mass) of the first ink is 8.0% by mass or more based on a total amount of the first ink.

4. The ink jet recording method according to claim 1, wherein the pigment as the particulate component in the first ink comprises titanium dioxide.

5. The ink jet recording method according to claim 1, wherein the pigment in the second ink comprises at least one selected from the group consisting of carbon black and an organic pigment.

6. The ink jet recording method according to claim 1, wherein a water-soluble organic solvent content (% by mass) of the second reaction liquid is 25.0% by mass or less based on a total mass of the second reaction liquid.

7. The ink jet recording method according to claim 1, wherein the reactants in the first reaction liquid and the second reaction liquid each comprises a polyvalent metal salt.

8. The ink jet recording method according to claim 7, wherein the polyvalent metal salt in each of the first reaction liquid and the second reaction liquid comprises magnesium sulfate.

9. The ink jet recording method according to claim 7, wherein the reactants in the first reaction liquid and the second reaction liquid each further comprises a cationic resin.

10. An ink jet recording apparatus comprising a recording head configured to eject:
a first ink that is an aqueous ink comprising at least one particulate component selected from the group consisting of a pigment and a resin particle;
a second ink that is an aqueous ink comprising a pigment;
a first reaction liquid that is an aqueous reaction liquid comprising a reactant that reacts with at least one selected from the group consisting of the first ink and the second ink; and
a second reaction liquid that is an aqueous reaction liquid comprising a reactant that reacts with at least one selected from the group consisting of the first ink and the second ink,
to a recording medium to overlap each other in at least an area of the recording medium to form an image, wherein the apparatus performs:
a first reaction liquid applying step of applying the first reaction liquid to the recording medium;
a first ink applying step of applying the first ink to the recording medium after the first reaction liquid applying step;
a second ink applying step of applying the second ink to the recording medium after the first reaction liquid applying step; and
a second reaction liquid applying step to the recording medium after the first reaction liquid applying step,
the recording medium exhibits a water absorption of 10 mL/m² or less for a period of 30 ms^{1/2} from the beginning of contact with water when measured by a Bristow method, and
the second reaction liquid has a higher surface tension than the first reaction liquid.
